(19) United States
(12) Patent Application Publication
(10) Pub. No.: US 2006/0165898 A1
(43) Pub. Date: Jul. 27, 2006

(54) Controlling flame temperature in a flame spray reaction process

(75) Inventors: Toivo T. Kodas, Albuquerque, NM (US); George P. Fotou, Albuquerque, NM (US); Miodrag Oljaca, Albuquerque, NM (US); Ned Jay Hardman, Albuquerque, NM (US); Prakash Kumar, Albuquerque, NM (US)

Correspondence Address: Jaimes Sher, Esq.;Cabot Corporation, 5401 Venice Avenue NE, Albuquerque, NM, 87113, US

(73) Assignee: Cabot Corporation, Boston, MA (US)

(21) Appl. No.: 11/335,685

(22) Filed: Jan. 20, 2006

Related U.S. Application Data
(60) Provisional application No. 60/645,985, filed on Jan. 21, 2005.

(51) Int. Cl. H05H 1/26; B05D 1/08; B05C 11/00; B05C 5/00

(52) U.S. Cl. 427/258; 427/446; 427/372.2; 118/47; 118/300

(57) ABSTRACT

The invention relates to a process for decreasing flame temperature in a flame spray reaction system, the process comprising the steps of providing a precursor medium comprising a precursor to a component; flame spraying the precursor medium under conditions effective to form a population of product particles; and decreasing the flame temperature by contacting the flame with a cooling medium. The process of the present invention allows for the control of the size, composition and morphology of the nanoparticles made using the process. The invention also relates to a nozzle assembly that comprises a substantially longitudinally extending atomizing feed nozzle that comprises an atomizing medium conduit and one or more substantially longitudinally extending precursor medium feed conduits. The nozzle assembly of the present invention is used in a flame spray system to produce nanoparticles using the processes described herein.

### CROSS REFERENCE TO RELATED APPLICATION

This application claims the benefit of U.S. Provisional Application Ser. No. 60/645,985, filed Jan. 21, 2005, the entire contents of which are incorporated herein by reference.

### FIELD OF INVENTION

The present invention relates to flame spray reaction processes, and more particularly, to controlling flame temperature in flame spray reaction processes.

### BACKGROUND OF THE INVENTION

There is currently a heightened interest in the use of nanoparticles for a variety of applications. However, nanoparticles may range significantly in size and other properties. For example, particles ranging in size from 1 nm to 500 nm are still considered nanoparticles. For different applications, however, particle sizes or particle size distributions may vary based on product or processing requirements. Also, for some applications, certain characteristics for other properties may be desired, such as the density or morphology of the nanoparticles.

For example, in some applications it may be desirable to have smaller-size nanoparticles, while for other applications larger-size nanoparticles may be desired. Additionally, for some applications it may be preferred that the nanoparticles be spherical and unagglomerated, while in other applications it may be preferred that the nanoparticles be agglomerated, or aggregated, into larger units of aggregates with controlled structure. Also, desired properties of the nanoparticles may vary depending upon the composition of the nanoparticles.

Conventional processes for making nanoparticles have achieved some success in making nanoparticles with certain compositions and other properties. New processes are desirable, however, that provide additional capabilities to satisfy a need for a broader range of nanoparticulate compositions and properties.

Recently, nanoparticles have been synthesized in flame spray reactors. A flame spray reactor is a reactor in which the reactants are combusted or otherwise reacted in a flame in the reactor. The products formed in the flame are then carried through the reactor, cooled and collected. One problem associated with conventional flame spray reaction systems is that it is difficult to control the temperature of the flame therein. Excessively high temperatures may be undesirable as they increase the formation of side reaction byproducts. Conversely, excessively low temperatures may result in undesirably low conversions. Thus, the need exists for processes and devices for controlling flame temperature in a flame spray reaction system.

### SUMMARY OF THE INVENTION

The present invention provides processes for forming nanoparticles through a flame spray process. In one aspect, the invention relates to a process for decreasing flame temperature in a flame spray reaction system, the process comprising the steps of (a) providing a precursor medium comprising a precursor to a component; (b) flame spraying the precursor medium under conditions effective to form a population of product particles; and (c) decreasing the flame temperature by contacting said flame with a cooling medium. In some embodiments, steps (b) and (c) occur simultaneously.

In another aspect, the invention relates to a process for decreasing flame temperature in a flame spray reaction system, the process comprising the step of decreasing the flame temperature at a rate of about 900° C. per second to about 10,000° C. per second by contacting said flame with a cooling medium.

In another aspect, the invention relates to a process for decreasing flame temperature in a flame spray reaction system, the process comprising the step of decreasing the flame temperature by directly contacting said flame with a cooling medium at an angle of about 25 degrees to about 180 degrees.

In still another aspect, the invention relates to a nozzle assembly, comprising: (a) a substantially longitudinally extending atomizing feed nozzle comprising an atomizing medium conduit and one or more substantially longitudinally extending precursor medium feed conduits; and (b) a substantially longitudinally extending sheath medium nozzle.

In yet another aspect, the invention relates to a nozzle assembly, comprising: (a) a substantially longitudinally extending atomizing feed nozzle comprising an atomizing medium conduit and one or more precursor medium feed conduits, (i) wherein the atomizing medium conduit has a first end for receiving an atomizing medium from an atomizing medium source and a second end through which the atomizing medium exits the atomizing feed nozzle, and (ii) wherein the precursor medium feed conduit has a first end for receiving a precursor medium from a precursor medium source and a second end through which the precursor medium exits the atomizing feed nozzle; and (b) at least one substantially longitudinally extending sheath medium nozzle comprising a first end for receiving a sheath medium from a sheath medium source and a second end through which the sheath medium exits the sheath medium nozzle.

In another aspect, the invention relates to a nozzle assembly comprising: (a) a substantially longitudinally extending spray nozzle atomizer; and (b) a substantially longitudinally extending sheath medium nozzle.

In still another aspect, the invention relates to a method of making product particles, the method comprising: introducing into a flame reactor heated by at least one flame, a precursor medium comprising a precursor to a component; forming the product particles, the forming comprising transferring substantially all of the precursor to a component through a gas phase of a flowing stream in the flame reactor and growing the product particles in the flowing stream to a weight average particle size in a range having a lower limit of 1 nanometer and an upper limit of 500 nanometers; and prior to completion of the growing, quenching the flowing stream in a first quenching step to reduce the temperature of the product particles, the quenching step comprising introducing into the flowing stream a cooling medium that is at a lower temperature than the flowing stream.

In yet another aspect, the invention relates to a method of making metal-containing product particles, the method comprising: introducing into a flame reactor heated by at least one flame a precursor medium comprising a precursor to a component; forming the product particles, the forming comprising transferring substantially all of the precursor to a component through a gas phase of a flowing stream in the flame reactor and growing in the flowing stream the product particles comprising a metal phase to a weight average particle size in a range having a lower limit of 1 nanometer and an upper limit of 500 nanometers; and quenching the flowing stream to reduce the temperature of the product particles, wherein the quenching comprises introducing into the flowing stream a cooling medium that is at a lower temperature than the flowing stream; and the quenching follows at least a portion of the growing.

In still another aspect, the invention relates to the use of a nozzle assembly, comprising (a) a substantially longitudinally extending atomizing feed nozzle comprising an atomizing medium conduit and one or more substantially longitudinally extending precursor medium feed conduits; and (b) a substantially longitudinally extending sheath medium nozzle, to make product particles, wherein said product particles have a weight average particle size in a range having a lower limit of 1 nanometer and an upper limit of 500 nanometers.

### BRIEF DESCRIPTION OF THE DRAWINGS

The present invention will be better understood in view of the following non-limiting figures, wherein:

FIG. 1 presents a flow diagram showing how nanoparticles and optionally nanoparticle agglomerates may be formed according to one aspect of the present invention;

FIG. 2 presents a cross-sectional side view of a flame reactor having a flame cooling system according to one aspect of the invention;

FIG. 3 provides a cross-sectional side view of a flame reactor for use in one aspect of the invention;

FIG. 4 provides a cross-sectional side view of a flame reactor for use in another aspect of the invention;

FIG. 5 provides a cross-sectional side view of a flame reactor for use in another aspect of the invention;

FIG. 6 provides a cross-sectional side view of a flame reactor for use in another aspect of the invention;

FIG. 7 provides a cross-sectional side view of a flame reactor for use in another aspect of the invention; and

FIG. 8 provides a cross-sectional side view of a flame reactor for use in another aspect of the invention.

FIG. 9 provides a cross-sectional side view of a nozzle assembly for use in still another aspect of the invention;

FIG. 10 provides a front-end cross sectional view of the nozzle assembly in FIG. 9;

FIG. 10A provides a nozzle assembly comprising a plurality of fuel/oxidant conduits where the fuel/oxidant conduits are in the form of a honeycomb;

FIG. 11A provides a front perspective view of a nozzle assembly comprising a fuel/oxidant conduit and a sheath medium nozzle support structure comprising a plurality of substantially longitudinally extending sheath medium nozzles that are arranged in a cylindrical fashion about the nozzle assembly;

FIG. 11B provides a front perspective view of a nozzle assembly comprising a fuel/oxidant conduit and a sheath medium nozzle support structure where the sheath medium nozzle support structure is in the form of a honeycomb;

FIG. 11C provides a front perspective view of a nozzle assembly comprising a fuel/oxidant conduit and a sheath medium nozzle support structure comprising a plurality of sheath medium nozzles that extend substantially parallel to the atomizing feed nozzle;

FIG. 12A provides a front-end view of an array of four atomizing feed nozzles and five sheath medium nozzles arranged on the sheath medium nozzle support structure in a cross shape;

FIG. 12B provides a front-end view of an array of a plurality of sheath medium nozzles circumscribing two atomizing feed nozzles;

FIG. 12C provides a front-end view of an array of a plurality of sheath medium nozzles circumscribing three atomizing feed nozzles, where the atomizing feed nozzles are arranged in a triangular shape; and

FIG. 12D provides a front-end view of an array of a plurality of sheath medium nozzles circumscribing five atomizing feed nozzles, where the atomizing feed nozzles are arranged in a cross shape.

### DETAILED DESCRIPTION OF THE INVENTION

I. Introduction

According to processes of the present invention, a precursor medium is introduced into a flame reactor, which is a reactor having an internal reactor volume directly heated by one or more than one flame when the reactor is operated. By directly heated, it is meant that the hot discharge of a flame flows into the internal reactor volume. In the flame reactor, the precursor medium is heated in a flame under conditions effective to form product particles, e.g., nanoparticles, having desirable characteristics.

In one aspect, the present invention is directed to a process for decreasing flame temperature in a flame reactor. The process comprises the steps of: (a) providing a precursor medium comprising a nongaseous precursor to a component; (b) flame spraying the precursor medium under conditions effective to form a population of product particles, e.g., nanoparticles; and (c) decreasing the flame temperature by contacting said flame with a cooling medium. In one embodiment, the product particles comprise particles, e.g., nanoparticles, selected from the group consisting of catalyst particles, phosphor particles, magnetic particles and particles with specific electrical properties (e.g., conductive, resistive, dielectric, etc.). In another embodiment, the process further comprises the steps of: (c) collecting the product particles; and (d) dispersing the product particles in a liquid medium. The liquid medium may then be applied onto a surface (e.g., by ink jet printing, screen printing, intaglio printing, gravure printing, flexographic printing, and lithographic printing). The surface may, in turn, be heated to a maximum temperature below 500° C. to form at least a portion of an electronic component. For example, the surface may be heated to form at least a portion of a feature selected from the group consisting of a conductor, resistor, phosphor, dielectric, and a transparent of conducting oxide. The feature optionally comprises a ruthenate resistor (i.e., a resistor comprising a mixed metal oxide that contains ruthenium, including, but not limited to bismuth ruthenium oxide, and strontium ruthenium oxide); a phosphor; or a titanate dielectric.

In another embodiment, the process further comprises the steps of: (c) collecting the product particles; and (d) forming an electrode from the product particles. The electrode may comprise a fuel cell electrode. Preferably, the product particles exhibit corrosion resistance. Additionally, or alternatively, the product particles exhibit high temperature thermal stability and high surface area. In a preferred embodiment, the product particles maintain a surface area of at least 30 m²/g after exposure to air at 900° C for 4 hours.

In still another embodiment, the process further comprises the steps of: (c) collecting the product particles; and (d) forming an optical feature from the product particles. Optical features are described, for example, in co-pending U.S. Patent Application bearing Attorney Docket No. 2006A002, entitled “Security Features, Their Use, and Processes for Making Them,” filed on Jan. 13, 2006, the entirety of which is incorporated herein by reference.

In another aspect, the invention is directed to a process for decreasing flame temperature in a flame reactor, the process comprising the step of decreasing the flame temperature at a rate of about 900° C. per second to about 10,000° C. per second by contacting said flame with a cooling medium.

In yet another aspect, the invention is directed to a process for decreasing flame temperature in a flame reactor, the process comprising the step of decreasing the flame temperature by directly contacting said flame with a cooling medium at an angle of about 25 degrees to about 180 degrees, e.g., from about 25 degrees to about 90 degrees.

In still another aspect, the invention provides a nozzle assembly comprising (a) a substantially longitudinally extending atomizing feed nozzle comprising an atomizing medium conduit and one or more substantially longitudinally extending precursor medium feed conduits; and (b) a substantially longitudinally extending sheath medium nozzle.

In another aspect, the invention provides a nozzle assembly comprising (a) a substantially longitudinally extending atomizing feed nozzle comprising an atomizing medium conduit and one or more precursor medium feed conduits, (i) wherein the atomizing medium conduit has a first end for receiving an atomizing medium from an atomizing medium source and a second end through which the atomizing medium exits the atomizing feed nozzle, and (ii) wherein the precursor medium feed conduit has a first end for receiving a precursor medium from a precursor medium source and a second end through which the precursor medium exits the atomizing feed nozzle; and (b) at least one substantially longitudinally extending sheath medium nozzle comprising a first end for receiving a sheath medium from a sheath medium source and a second end through which the sheath medium exits the sheath medium nozzle.

In another aspect, the invention provides a nozzle assembly comprising (a) a substantially longitudinally extending spray nozzle atomizer; and (b) a substantially longitudinally extending sheath medium nozzle. In one embodiment, the spray nozzle atomizer is a two-fluid nozzle, a three-fluid nozzle, a four-fluid nozzle, an ultrasonic nozzle or an air-less nozzle.

In yet another aspect, the invention is directed to a method of making nanoparticulates, the method comprising: introducing into a flame reactor heated by at least one flame, a nongaseous precursor including a component for inclusion in a material of the nanoparticulates; forming the nanoparticulates, the forming comprising transferring substantially all of the component of the precursor through a gas phase of a flowing stream in the flame reactor and growing the nanoparticulates in the flowing stream to a weight average particle size in a range having a lower limit of 1 nanometer and an upper limit of 500 nanometers; and prior to completion of the growing, quenching the flowing stream in a first quenching step to reduce the temperature of the nanoparticulates, the quenching step comprising introducing into the flowing stream a quench fluid that is at a lower temperature than the flowing stream. In one embodiment, at least a portion of the growing occurs after the first quenching step. In another embodiment, the growing ceases after the first quenching step. In another embodiment, the quench fluid comprises gas. In another embodiment, the quench fluid comprises a disperse nongaseous material and during the first quenching step, at least a portion of the disperse nongaseous material vaporizes, consuming heat associated with the vaporization. In another embodiment, the nongaseous disperse material comprises liquid droplets of liquid. In a preferred embodiment, the liquid is water. In yet another embodiment, the method further comprises a second step of quenching the flowing stream (e.g., a second quenching step) to further reduce the temperature of the product particles. In one embodiment after the second quenching step, the method comprises collecting the nanoparticulates, the collecting comprising removing the nanoparticulates from the flowing stream. In still another embodiment, the nongaseous precursor is a first precursor for the nanoparticulates and the method further comprising adding a second precursor for the nanoparticulates into the flowing stream, with at least a portion of the adding occurring during or after the quenching.

In yet another aspect, the invention relates to a method of making nanoparticulates, the method comprising: introducing into a flame of a flame reactor a nongaseous precursor including a component for inclusion in a material of the nanoparticulates; forming the nanoparticulates, the forming comprising transferring substantially all of the component of the nongaseous precursor through a gas phase of a flowing stream in the flame reactor and growing in the flowing stream the nanoparticulates to a weight average particle size in a range having a lower limit of 1 nanometer and an upper limit of 500 nanometers; and during at least a portion of the introducing, flowing a barrier gas around the outer periphery of the flame.

In another aspect, the invention relates to a method of making metal-containing nanoparticulates, the method comprising: introducing into a flame reactor heated by at least one flame a nongaseous precursor including a component for inclusion in a material of the nanoparticulates, the material comprising a metal; forming the nanoparticulates, the forming comprising transferring substantially all of the component of the nongaseous precursor through a gas phase of a flowing stream in the flame reactor and growing in the flowing stream the nanoparticulates comprising the metal phase to a weight average particle size in a range having a lower limit of 1 nanometer and an upper limit of 500 nanometers; and quenching the flowing stream to reduce the temperature of the nanoparticulates, wherein the quenching comprises introducing into the flowing stream a quench fluid that is at a lower temperature than the flowing stream; and the quenching follows at least a portion of the growing. In one embodiment, at least a portion of the growing follows the quenching. In another embodiment, the quench fluid is inert. In still another embodiment, the quench fluid comprises a reactive material. In another embodiment, the reactive material comprises a precursor including a supplemental component for inclusion in the nanoparticulates, and wherein the method further comprises the step of reacting the precursor in the flowing stream to add the supplemental component nanoparticulates. In another embodiment, the quench fluid comprises droplets dispersed in a gas. In still another embodiment, the droplets comprise water and during the quenching at least a portion of the water vaporizes to consume heat in the flowing stream.

In still another aspect, the invention relates to a method of making product particles, the method comprising: introducing into a flame reactor heated by at least one flame, a precursor medium comprising a precursor to a component; forming the product particles, the forming comprising transferring substantially all of the precursor to a component through a gas phase of a flowing stream in the flame reactor and growing the product particles in the flowing stream to a weight average particle size in a range having a lower limit of 1 nanometer and an upper limit of 500 nanometers; and prior to completion of the growing, quenching the flowing stream in a first quenching step to reduce the temperature of the product particles, the quenching step comprising introducing into the flowing stream a cooling medium that is at a lower temperature than the flowing stream.

In yet another aspect, the invention relates to a method of making product particles, the method comprising: introducing into a flame of a flame reactor a precursor medium comprising a precursor to a component; forming the product particles, the forming comprising transferring substantially all of the precursor to a component through a gas phase of a flowing stream in the flame reactor and growing in the flowing stream the product particles to a weight average particle size in a range having a lower limit of 1 nanometer and an upper limit of 500 nanometers; and during at least a portion of the introducing, flowing a sheath medium around the outer periphery of the flame.

In another aspect, the invention relates to a method of making metal-containing product particles, the method comprising: introducing into a flame reactor heated by at least one flame a precursor medium comprising a precursor to a component; forming the product particles, the forming comprising transferring substantially all of the precursor to a component through a gas phase of a flowing stream in the flame reactor and growing in the flowing stream the product particles comprising a metal phase to a weight average particle size in a range having a lower limit of 1 nanometer and an upper limit of 500 nanometers; and quenching the flowing stream to reduce the temperature of the product particles, wherein the quenching comprises introducing into the flowing stream a cooling medium that is at a lower temperature than the flowing stream; and the quenching follows at least a portion of the growing.

II. Precursor Medium

As indicated above, in a preferred embodiment of the present invention, a precursor medium is introduced into a flame reactor. The composition and properties of the precursor medium may vary widely depending, for example, on the composition and properties that are desired in the product particles formed by the flame spray process as well as how the precursor medium affects the operating characteristics, e.g., temperature and residence time, of the flame reactor. As used herein, “precursor medium” means a flame-sprayable composition comprising a nongaseous precursor to a component for inclusion in product particles formed by a flame spray process. Additionally, the precursor medium preferably comprises a liquid vehicle. The precursor medium optionally further comprises one or more particles (e.g., substrate particles). In some embodiments, the precursor medium may comprise one or more of the following: viscosity modifiers (e.g., methanol, ethanol, isopropanol and the like), surfactants (e.g., alkyl sulfates, alkyl sulfonates, alkyl benzene sulfates, alkyl benzene sulfonates, fatty acids, sulfosuccinates, phosphates, and the like), emulsifiers (e.g., monoglycerides, polysaccharides, sorbitan trioleate, tall oil esters, polyoxyethylene ethers, and the like) or stabilizers (e.g., polyvinyl pyrrolidone, poly(propylenoxide) amines, polyamines, polyalcohols, polyoxides, polyethers, polyacrylamides, polyacrylates, and the like). In some aspects of the invention, the precursor medium includes a liquid nongaseous precursor to a component and particles, but not a liquid vehicle.

The liquid vehicle optionally includes one or more than one of any of the following liquid phases: organic, aqueous, and/or organic/aqueous mixtures. Some nonlimiting examples of organic liquids that may be included in the liquid vehicle include alcohols (e.g., methanol, ethanol, isopropanol, butanol), organic acids, glycols, aldehydes, ketones, ethers, aromatics (e.g., toluene and xylene), alkanes (e.g., hexane and isooctane), waxes, or fuel oils (e.g., stoddard, kerosene or diesel oil). In addition to or instead of the organic liquid, the liquid vehicle may include an inorganic liquid, which will, in some embodiments, be aqueous-based. Some nonlimiting examples of such inorganic liquids include aqueous solutions, which may be pH neutral, acidic or basic. A precursor medium, from which droplets are generated, may include a mixture of mutually soluble liquid components, or the precursor medium may contain multiple distinct liquid phases (e.g., an emulsion). Thus, the precursor medium may be a mixture of two or more mutually soluble liquid components. For example, the liquid vehicle may comprise a mixture of mutually soluble organic liquids or a mixture of water with one or more organic liquids that are mutually soluble with water (e.g., some alcohols, ethers, ketones, aldehydes, etc.). The precursor medium may also include multiple liquid phases, such as in an emulsion. For example, precursor medium could include an oil-in-water or a water-in-oil emulsion. In addition to multiple liquid phases, the precursor medium, and the droplets formed therefrom, may include multiple liquid phases and one or more solid phases (i.e., suspended particles). As one example, the precursor medium, and the droplets formed therefrom, may include an aqueous phase, an organic phase and a solid particle phase. As another example, the precursor medium, and the droplets formed therefrom, may include an organic phase, particles of a first composition and particles of a second composition.

Moreover, a liquid vehicle, or component thereof, in the precursor medium may have a variety of functions. For example, a liquid the vehicle may be a solvent for the nongaseous precursor, and the nongaseous precursor may be dissolved in the liquid vehicle when introduced into the flame reactor. As another example, the liquid vehicle may be or may include a component that is a fuel or an oxidant for combustion in a flame of the flame reactor or a propellant (e.g., liquid propane or supercritical CO₂) for dispersion of liquid. Such fuel or oxidant in the precursor medium may be the primary or a supplemental fuel or oxidant for driving the combustion in a flame. The liquid vehicle may provide one or more of any of these or other functions, e.g., the liquid vehicle may provide a supplemental fuel, such as one of the fuels described above. A supplemental fuel may be required in some cases where the precursor medium has a low enthalpy of combustion. The supplemental fuel provides sufficient heat to completely evaporate the atomized precursor medium droplets and convert them completely to product particles.

In one embodiment, the precursor medium further comprises particles, e.g., support or substrate particles. In this aspect, the particles from the precursor medium may form the core (or a substantial portion of the core) of composite particles formed by the process of the present invention. As used herein, the term “particles,” without modification, refers to the particles contained in the precursor medium that is introduced in the flame reactor rather than the product particles, e.g., composite particles, formed by the flame spray process. In this embodiment, the precursor to the component forms the component on the support particles (e.g., as nanoparticles or as layer) to form product particles having a core/shell structure.

In one embodiment of the core/shell aspect of the invention, the component that is formed by flame spraying the precursor medium coats the entire surface of the particles, thereby forming a solid shell around the particles. In another embodiment of the core/shell aspect of the invention, the component that is formed by flame spraying the precursor medium decorates the surface of the support particle, such that part of, if not the entire surface of the support particle is covered with finely dispersed nanoparticles of the component (e.g., a noble metal dispersed on a high surface area metal oxide core particle).

In yet another embodiment, the support particle functions as a matrix or support structure. The component that is formed by flame spraying the precursor medium may then be distributed uniformly within this matrix to form product particles that comprise two phases where the component is uniformly distributed throughout the support particle (e.g., SiO₂:TiO₂). In still another embodiment, the component that is formed by flame spraying the precursor medium may combine with the support particle (e.g., dissolve in the support particle) to form a product particle that has a single phase (e.g., SiO₂:Al₂O₃ and CeO₂:ZrO₂). In yet another embodiment, the first precursor medium, rather than forming distinct particles or layers on the support particles, forms a matrix that functions as a spacer between support particles. The product particles, therefore, comprise a plurality of support particles separated from each other but “trapped” inside a second phase which is the reaction product of the precursor in the first precursor medium.

It is contemplated that the particles from the precursor medium may agglomerate during flame spraying to form an aggregated structure that forms the core or a substantial portion of the core of the composite particles. In this aspect, the core comprises a plurality of particles derived from the precursor medium. The component formed from the nongaseous precursor may also be present in the core, e.g., interspersed in the interstitial spaces formed as the particles agglomerate, of the product particles formed according to this aspect of the invention.

The particles in the precursor medium may be nanoparticles. In some instances, however, the particles in the precursor medium can be from about 5 to 20 microns. The particles in the precursor medium are preferably less than about 1 micron in size. As used herein, the term “nanoparticles,” means particles having a weight average particle size (d50 value) of about 500 nm or smaller. In one embodiment, the nanoparticles have a d50 value of about 100 nm or smaller.

The product particles produced using the processes described herein can have a variety of morphologies, e.g., solid spherical particles of one component decorated with nanoparticles of different component, solid particles with different levels of agglomeration, fractal-like aggregates of support particles decorated or coated with nanoparticles of a different component, or particles with hierarchical structure spanning nanometer to micron size ranges.

In some embodiments, the support particles can be fibers. This morphology offers many advantages, e.g., low pressure drop when these particles are packed in a chromatographic column used for bioseparations. Fibers, however, usually have a very low surface area which limits their applications. The processes of the invention, however, allow coating of low surface area fibers with nanoparticles that enhance the surface area of the former. Similarly, surface enhancement can be achieved for other structures, e.g., dense or hollow micron-sized support particles.

As indicated above, the precursor medium includes a nongaseous precursor to a component for inclusion in the nanoparticles formed by the flame spray process. By “component” it is meant at least some identifiable portion of the nongaseous precursor that becomes a part of the composite particles. For example, the component could be the entire composition of the nongaseous precursor when that entire composition is included in the composite particles. More often, however, the component will be something less than the entire composition of the nongaseous precursor, and may be only a constituent element present in both the composition of the nongaseous precursor and the nanoparticles. For example, it may be the case that in the flame reactor the nongaseous precursor decomposes, and one or more than one element in a decomposition product then becomes part of the product particles, either with or without further reaction of the decomposition product.

In a preferred implementation, the precursor medium, comprising the nongaseous precursor and a liquid vehicle, may also contain suspended solids or particulates. Some nonlimiting examples of classes of materials that may be used as the nongaseous precursor include: nitrates, oxalates, acetates, acetyl acetonates, carbonates, carboxylates, acrylates and chlorides. Other examples of nongaseous precursors to a component for inclusion in the nanoparticles are disclosed in U.S. patent application Ser. Nos. 11/199,512 and 11/199,100, both of which were filed Aug. 8, 2005, and the entireties of which are each incorporated herein by reference.

III. Flame Reactor Operation

1. Introduction of Precursor Medium into Flame Reactor

The precursor medium may be introduced into the flame reactor in any convenient way. By being introduced into the flame reactor, it is meant that the precursor medium is either introduced into one or more than one flame of the reactor (i.e., delivered as feed to the flame) or introduced into a hot zone in the internal reactor volume directly heated by one or more than one flame.

In a preferred embodiment, the precursor medium is atomized and introduced into the flame reactor as a nongaseous disperse phase. The disperse phase may be, for example, in the form of droplets. The term “droplet” used in reference to such a disperse phase refers to a disperse domain characterized as including liquid (often the droplet is formed solely or predominantly of liquid, although the droplet may comprise multiple liquid, phases and/or particles suspended in the liquid). The term “particle” used in reference to such a disperse phase refers to a disperse domain characterized as being solid. The droplets preferably have a composition substantially similar to that of the precursor medium from which they were formed.

As noted above, in one embodiment, the disperse phase droplets may comprise particles suspended in the droplets. Such suspended particles preferably act as nucleates. Preferably, the support particles are not soluble to any significant extent in any liquid components contained in the precursor medium.

When the precursor medium is introduced into the flame reactor in a disperse phase, as discussed above, in one preferred embodiment the disperse phase is dispersed in a gas phase. The gas phase may include any combination of gaseous components in any concentrations. The gas phase may include only components that are inert (i.e. nonreactive) in the flame reactor or the gas phase may comprise one or more reactive components (i.e., decompose or otherwise react in the flame reactor with oxidants like O₂, CO and the like or with fuels like light alkanes, hydrogen, and the like). When the nongaseous precursor is fed to a flame, the gas phase may comprise a gaseous fuel and/or oxidant for combustion in the flame. A nonlimiting example of a gaseous oxidant is gaseous oxygen, which could be provided by making the gas phase from or including air. A nonlimiting example of another possible gaseous oxidant is carbon monoxide. Nonlimiting examples of gaseous fuels that could be included in the gas phase include hydrogen gas and gaseous organics, such as for example C₁-C_{y} hydrocarbons (e.g., methane, ethane, propane, butane). In one embodiment, the gas phase includes an oxidant (normally oxygen in air), and fuel is delivered separately to the flame. Alternatively, the gas phase may include both fuel and oxidant premixed for combustion in a flame. Optionally, the gas phase includes a gas mixture containing more than one oxidant and/or more than one fuel. The gas phase includes one or more than one gaseous precursor for a material of the nanoparticles. Such a gaseous precursor(s) would be in addition to the nongaseous precursor in the disperse phase that is derived from the precursor medium (e.g., volatile precursors such as SiCl₄, TiCl₄, and other halides). The component provided by a gaseous precursor for inclusion in the nanoparticles may be the same or different than the component provided by the nongaseous precursor. One situation when the gas phase includes a gaseous precursor is when making nanoparticles that include an oxide material, and the gaseous precursor is oxygen gas. Sufficient oxygen gas should be included, however, to provide excess over that consumed by combustion when the nongaseous precursor is fed to the flame. Moreover, the gas phase may include any other gaseous component that is not inconsistent with manufacture of the desired nanoparticles, or that serves some function other than those noted above (e.g., cooling, dilution, etc).

In one embodiment, the disperse phase of the flowing stream includes a liquid vehicle, the liquid vehicle containing the dissolved nongaseous precursor, which includes or forms the component for inclusion in the nanoparticles. In this embodiment, the generating step includes steps for dispersing the liquid vehicle into droplets within the gas phase. This may be performed using any suitable device that disperses liquid into droplets, such as for example, a spray nozzle. The spray nozzle may be any spray nozzle which is useful for dispersing liquids into droplets. Some examples include ultrasonic spray nozzles, multi-fluid spray nozzles and pressurized spray nozzles.

Ultrasonic spray nozzles generate droplets of liquid by using piezoelectric materials that vibrate at ultrasonic frequencies to break up a liquid into small droplets. Pressurized nozzles use pressure and a separator or screen in order to break up the liquid into droplets. In some cases, pressurized nozzles may involve use of some vapor that is generated from the liquid itself in order to pressurize and break up the liquid into droplets. One advantage of using ultrasonic and pressurized nozzles is that an additional fluid is not required to generate liquid droplets. This may be useful in situations where the nongaseous precursor dissolved in the liquid is sensitive and/or incompatible with other common fluids used in multi-fluid spray nozzles.

In addition to the use of a spray nozzle for dispersing the liquid medium, any other suitable device or apparatus for generating disperse droplets of liquid may be used in the generating step. One example of a device that is useful in generating droplets of liquid is an ultrasonic generator. An ultrasonic generator uses transducers to vibrate liquids at very high frequencies which break up the liquid into droplets. One example of an ultrasonic generator that is useful with the present invention is disclosed in U.S. Pat. No. 6,338,809, incorporated herein by reference in its entirety. Another example of a device that is useful in generating droplets of liquid is a high energy atomizer such as those used in carbon black production.

2. Flame Formation and Control

Upon its introduction into the flame reactor, preferably as a disperse phase, a component in the precursor medium, e.g., the liquid vehicle, acts as a fuel and bums in an oxidizing environment to form a flame. In various aspects of the invention, the flame reactor includes one or more than one flame that directly heats an interior reactor volume. Each flame of the flame reactor will be generated by a burner, through which oxidant and the fuel (e.g., the liquid vehicle) are fed to the flame for combustion. The burner may be of any suitable design for use in generating a flame, although the geometry and other properties of the flame will be influenced by the burner design. Some exemplary burner designs that may be used to generate a flame for the flame reactor are discussed in detail in U.S. Provisional Patent Application No. 60/645,985, filed Jan. 21, 2005, the entirety of which is incorporated herein by reference. Each flame of the flame reactor may be oriented in any desired way. Some nonlimiting examples of orientations for the flame include horizontally extending, vertically extending or extending at some intermediate angle between vertical and horizontal. When the flame reactor has a plurality of flames, some or all of the flames may have the same or different orientations. A preferred burner design is described in greater detail below in section IV.

Each flame has a variety of properties (e.g., flame geometry, temperature profile, flame uniformity, flame stability), which are influenced by factors such as the burner design, properties of feeds to the burner, and the geometry of the enclosure in which the flame is situated.

One important aspect of a flame is its geometry, or the shape of the flame. Some geometries tend to provide more uniform flame characteristics, which promote manufacture of product particles having relatively uniform properties at high production rates (e.g., at 1 kg/h). One geometric parameter of the flame is its cross-sectional shape at the base of the flame perpendicular to the direction of flow through the flame. This cross-sectional shape is largely influenced by the burner design, although the shape may also be influenced by other factors, such as the geometry of the enclosure and fluid flows in and around the flame. Other geometric parameters include the length and width characteristics of the flame. In this context the flame length refers to the longest dimension of the flame longitudinally in the direction of flow (e.g., the distance from the burner tip to the flame apex) and flame width refers to the longest dimension across the flame perpendicular to the direction of flow. With respect to flame length and width, a wider, larger cross sectional area flame, has potential for more uniform temperatures across the flame, because edge effects at the perimeter of the flame are reduced relative to the total area of the flame. The area to volume ratio of the flame determines how fast the flame is quenched. A higher area to volume ratio flame cools off faster. Burner geometry, burner configuration and burner shape, in combination with the flame stoichiometry (e.g., whether the flame is fuel rich, oxidant rich or is burning a stoichiometric amount of oxidant), influence the stability and shape of the flame. The stability of the flame, in turn, influences the product particle properties (e.g., particle size distribution, morphology and phase composition) and their uniformity (e.g., uniformity of distribution of a component on particles).

Discharge from each flame of the flame reactor flows through a flow path, or the interior pathway of a conduit, defining the flame reactor. As used herein, “conduit” refers to a confined passage for conveyance of fluid through the flame reactor. When the flame reactor comprises multiple flames, discharge from any given flame may flow into a separate conduit for that flame or a common conduit for discharge from more than one of the flames. Ultimately, however, streams flowing from each of the flames preferably combine in a single conduit prior to discharge from the flame reactor.

A conduit defining the flame reactor may have a variety of cross-sectional shapes and areas available for fluid flow, with some nonlimiting examples including circular, elliptical, square or rectangular. In most instances, however, conduits having a circular cross-section are preferred. The presence of sharp comers or angles may create unwanted currents, flow disturbances and recirculation zones that can cause deposition on conduit surfaces and disturb the flame. Walls of the conduit may be made of any material suitable to withstand the temperature and pressure conditions within the flame reactor. The nature of the fluids flowing through the flame reactor may also affect the choice of materials of construction used at any location within the flame reactor. Temperature, however, may be the most important variable affecting the choice of conduit wall material. For example, quartz may be a suitable material for temperatures up to about 1200° C. As another example, for temperatures up to about 1500° C., possible materials for the conduit include refractory materials such as alumina, mullite or silicon carbide. As yet another example, for processing temperatures up to about 1700° C., graphite or graphitized ceramic might be used for conduit material. As another example, if the flame reactor will be at moderately high temperatures, but will be subjected to highly corrosive fluids, the conduit may be made of a stainless steel material or a high nickel alloy material (e.g., hastelloy, inconel, incoloy, etc.). These are merely some illustrative examples. The wall material for any conduit portion through any position of the flame reactor may be made from any suitable material for the processing conditions. Other examples of materials from which a flame reactor may be made include water-cooled or air-cooled jacketed heat exchangers with an internal wall made of glass or metal (e.g., stainless steel, carbon steel, aluminum, high nickel alloys, and the like).

The precursor medium is preferably introduced into the flame reactor in a very hot zone, also referred to herein as a primary zone, that is sufficiently hot to cause the component of the nongaseous precursor for inclusion in the nanoparticles to be transferred through the gas phase of a flowing stream in the flame reactor, followed by particle nucleation from the gas phase. Preferably, the temperature in at least some portion of this primary zone, and sometimes only in the hottest part of the flame, is high enough so that substantially all of materials flowing through that portion of the primary zone is in the gas phase. The component of the nongaseous precursor may enter the gas phase by any mechanism. For example, the nongaseous precursor may simply vaporize, or the nongaseous precursor may decompose and the component for inclusion in the product particles enters the gas phase as part of a decomposition product. Eventually, however, the component then leaves the gas phase as particle nucleation and growth occurs. Removal of the component from the gas phase may involve simple condensation as the temperature cools or may include additional reactions involving the component that results in a non-vapor reaction product. Remaining vaporized precursor may react on the surface of the already nucleated monomers by surface reaction mechanism. The monomers grow further to form primary particles by coagulation and instantaneous coalescence. As the temperature cools, coalescence rates decrease relative to coagulation and particles do not instantaneously coalesce. Instead, the particles partially fuse together to form aggregates.

In addition to this primary zone where the component of the nongaseous precursor is transferred into the gas phase, the flame reactor may also include one or more subsequent zones for growth or modification of the nanoparticles. In most instances, the primary zone will be the hottest portion within the flame reactor.

In addition to the shape of the flame(s), which may help control temperature profiles, it is also possible to control the feeds introduced into a burner. One example of an important control is the ratio of fuel (e.g., liquid vehicle) to oxidant that is fed into a flame. In some embodiments, the precursors introduced into a flame may be easily oxidized, and it may be desirable to maintain the fuel to oxidant ratio at a fuel rich ratio to ensure that no excess oxygen is introduced into the flame. Some materials that are preferably made in a flame that is fuel rich include materials such as metals, nitrides, and carbides. The fuel rich environment ensures that all of the oxygen that is introduced into a flame will be combusted and there will be no excess oxygen available in the flame reactor to oxidize the nanoparticles or precursors. In other words, there is a stoichiometric amount of oxygen in the feed that promotes the complete combustion of all the fuel present, thereby leaving no excess oxygen. In other embodiments, it may be desirable to have a fuel to oxidant ratio that is rich in oxygen. For example, when making metal oxide ceramics, it may be desirable to maintain the environment within a flame and in the flame reactor with excess oxygen. In yet other embodiments, the fuel to oxygen ratio introduced into the flame may not be an important consideration in processing the nanoparticles. In yet another embodiment, the flame is fuel-rich in order to produce a carbonaceous component in the particles that may be desirable for various reasons (e.g., conductivity and carbon matrix that can be removed by burning off).

In addition to the environment within the flame and the flame reactor, the fuel to oxidant ratio also controls other aspects of the flame. One particular aspect that is controlled by the flame is the flame temperature. If the fuel to oxidant ratio is at a fuel rich ratio then the flame reactor will contain fuel that is uncombusted. Unreacted fuel generates a flame that is at a lower temperature than if all of the fuel that is provided to the flame reactor is combusted. Uncombusted fuel will introduce carbon contamination in the product particles. Thus, in those situations in which it is desirable to have all of the fuel combusted in order to maintain the temperature of a flame at a high temperature, it will be desirable to provide to the flame reactor excess oxidant to ensure that all of the fuel provided to the flame or flame reactor is combusted. However, if it is desirable to maintain the temperature of the flame at a lower temperature, then the fuel to oxidant ratio may be fuel rich so that only an amount of fuel is combusted so that the flame does not exceed a desired temperature. The same effect can be obtained by using excess oxygen. The maximum flame temperature is obtained when the stoichiometric amount of oxygen is used. Excess oxygen will result in lower flame temperatures.

The total amount of fuel and oxidant fed into the flame determines the velocity of the combusted gases, which, in turn, controls the residence time of the primary particles formed in the flame. The residence time in the flame of the primary particles determine the product particle size and in some cases the morphology of the product particles. The relative ratio of oxygen to fuel also determines the concentration of particles in the flame which, in turn, determines the final product particle size and morphology. More dilute flames will make smaller or less aggregated particles.

The specific type of fuel will also affect the temperature of a flame. In addition to the temperature of the flame, the selection of a fuel may involve other considerations. Fuels that are used to combust and create the flame may be gaseous or nongaseous. The nongaseous fuels may be a liquid, solid or a combination of the two. In some cases, the fuel combusted to form the flame may also function as a solvent for the nongaseous precursor. For example, a liquid fuel may be used to dissolve a nongaseous precursor and be fed into a burner as dispersed droplets of the precursor medium containing the dissolved nongaseous precursor. The advantage of this is that the precursor is surrounded by fuel in each droplet which upon combustion provides optimum conditions for precursor conversion. In other embodiments, the liquid fuel may be useful as a solvent for the precursor but not contain enough energy to generate the required heat within the flame reactor for all of the necessary reactions. In this case, the liquid fuel may be supplemented with another liquid fuel and/or a gaseous fuel, which are combusted to contribute additional heat to the flame reactor. Nonlimiting examples of gaseous fuels that may be used with the method of the present invention include methane, propane, butane, hydrogen and acetylene. Some nonlimiting examples of liquid fuels that may be used with the method of the present invention include alcohols, toluene, acetone, isooctane, acids and heavier hydrocarbons such as kerosene and diesel oil.

One criterion that may be employed for the selection of gaseous and nongaseous fuels is the enthalpy of combustion of the fuel. The enthalpy of combustion of a fuel determines the temperature of the flame, the associated flame speed (which affects flame stability) and the ability of the fuel to burn cleanly without forming carbon particles. In addition, when the fuel is a liquid fuel, it is preferred that the nongaseous precursor is miscible in the liquid fuel.

As noted above, in some cases the fuel (e.g., the liquid vehicle) will be a combination of liquids. This embodiment is useful in situations when it is desirable to dissolve the nongaseous precursor into a liquid to disperse the nongaseous precursor. However, the nongaseous precursor may only be soluble in liquids that are low energy fuels. In this case, the low energy fuel (e.g., the liquid vehicle) may be used to dissolve the nongaseous precursor, while an additional higher energy fuel may supplement the low energy fuel to generate the necessary heat within the flame reactor. In some instances, the two liquid fuels may not be completely soluble in one another, in which case the liquid will be a multiphase liquid with two phases (i.e., an emulsion). Alternatively, the two liquid fuels may be introduced separately into the flame from separate conduits (e.g., in a multi-fluid nozzle case). In other instances the two liquids may be mutually soluble in each other and form a single phase. It should be noted that in other cases there may be more than two liquid fuels introduced into the flame, the liquids may be completely soluble in one another or may be in the form of an emulsion. It should also be noted that the nongaseous precursor that is introduced into the flame reactor may also, in addition to containing the component for inclusion in the nanoparticles, act as a fuel and combust to generate heat within the flame reactor.

The oxidant used in the method of the present invention to combust with the fuel to form the flame may be a gaseous oxidant or a nongaseous oxidant. The nongaseous oxidant may be a liquid, a solid or a combination of the two. However, preferably the oxidant is a gaseous oxidant and will optionally comprise oxygen. The oxygen may be introduced into the flame reactor substantially free of other gases such as a stream of substantially pure oxygen gas. In other cases, the oxygen will be introduced into the flame reactor with a mixture of other gases such as nitrogen, as is the case when using air. Although it is preferable to have a gaseous oxidant, in some cases the oxidant may be a liquid. Some examples of liquids that may be used as oxidants include inorganic acids. Also, the oxidant that is introduced into the flame reactor may be a combination of a gaseous oxidant or a liquid oxidant. This may be the case when it is desirable to have the nongaseous precursor dissolved in a liquid to disperse it, and it also desirable to have the oxidant located very close to the nongaseous precursor when in the flame reactor. In this case, the precursor may be dissolved in a liquid solvent that functions as an oxidant.

Conventional processes for forming nanoparticles from non-volatile precursors have not been able to form such narrow particle distributions. In particular, conventional processes for forming nanoparticles form undesirably large particles (e.g., on the order of greater than 1 μm) in addition to smaller nanoparticles in a bimodal particle size distribution. Such conventional processes require separation of the larger particles in order to provide a commercially useful population of desirably sized product particles, e.g., nanoparticles. The present processes, however, provide the ability to form a population of product nanoparticles that, as formed, comprise less than about 5 volume percent, less than about 3 volume percent, or less than about 2 volume percent particles having a particle size greater than 1 μm.

The flame spray processes of the present invention provide several additional benefits. For example, the processes desirably provide the ability to continuously manufacture product particles. In various aspects, the flame spraying step occurs continuously for at least 4 hours, at least about 8 hours, at least about 12 hours or at least about 16 hours per day.

The process also provides the ability to manufacture commercially valuable product particles at a fast rate. For example, the process optionally forms nanoparticles at a rate of at least about 0.1 kg/hr, at least about 1 kg/hr, at least about 1.5 kg/hr, at least about 2.0 kg/hr or at least about 10.0 kg/hr.

3. Process for Decreasing Flame Temperature

As indicated above, the present invention provides the ability to advantageously control flame temperature in a flame reactor. Controlling flame temperature in a flame spray process is important, for example, to control agglomeration, size, particle size distribution and morphology of the product particles that are produced in the processes of the invention. In one embodiment, the invention provides a process for decreasing flame temperature in a flame reactor. The process comprises the steps of (a) providing a precursor medium comprising a nongaseous precursor to a component; (b) flame spraying the precursor medium under conditions effective to form a population of product particles; and (c) decreasing the flame temperature by contacting said flame with a cooling medium. As used herein, the term “cooling medium,” means any medium capable of cooling a flame. Preferably, the cooling medium comprises a gas, a liquid or a combination of a gas and a liquid. In one embodiment, the cooling medium comprises air, oxygen, nitrogen, water vapor, argon, hydrogen or a combination thereof. Additionally or alternatively, the cooling medium comprises atomized water. Additionally, or alternatively, the cooling medium comprises oxidizing or reducing agents, or off gas recycle. Off gas may be used as the cooling medium after it is cooled and product particles are removed. The off gas stream is then recycled back to the reactor to cool the combustion products, thus eliminating the need for additional cooling gas introduction. If the cooling medium comprises atomized water, the cooling medium optionally comprises the water in an amount ranging from about 10 to about 100 weight percent, e.g., from about 50 to about 100 weight percent or from about 90 to about 100 weight percent, based on the total weight of the cooling medium.

FIG. 2 presents one non-limiting diagram of a flame spray reactor according to one aspect of the invention. As shown, cooling medium 205A/205B is introduced into nozzles 206A/206B, which traverse walls 207A/207B, respectively, of flame reactor 106. The cooling medium 205A/205B passes through the nozzles 206A/206B and enters the inner volume 208 of flame reactor 106 through cooling medium inlets 202A/202B, respectively.

With continuing reference to FIG. 2, feed 120, which includes the precursor medium, is introduced directly into the flame 114 through the burner 112. As discussed in greater detail below, fuel and oxidant for the flame 114 may be fed to the flame 114 as part of and/or separate from the feed 120 of the nongaseous precursor. In a preferred embodiment, the liquid vehicle preferably present in the precursor medium acts as the fuel.

The cooling medium can contact the flame at virtually any angle. As shown in FIG. 2, cooling medium introduction angles, θ₁ and θ₂, are the angles at which the cooling medium enters the flame reactor. Specifically, cooling medium introduction angles θ₁ and θ₂ are the angles formed between the center axes of nozzles 206A and 206B (shown by broken lines 201A/201B), respectively, and the inner surfaces 200A/200B formed by walls 207A/207B of flame reactor 106, as shown in FIG. 2.

The angle at which the cooling medium contacts the flame is important because the angle affects the entrainment of the cooling media into the flame and the cooling media's effectiveness in reducing the process temperature. Furthermore, certain cooling medium introduction angles provide better jet penetration into the main flame jet stream without disturbing significantly the flame. In some cases, if the cooling medium introduction angles θ₁ and θ₂ are too small, this may cause the cooling medium to preferentially cool the walls of the reactor rather than the flame itself. If, on the other hand, the cooling medium introduction angles θ₁ and θ₂ are too large, this may cause flame instabilities and poor jet penetration. Preferred cooling medium introduction angles θ₁ and θ₂ are from about 25 to about 90 degrees.

In yet another embodiment, the invention provides for a process for decreasing flame temperature in a flame reactor, the process comprising the step of decreasing the flame temperature by directly contacting said flame with a cooling medium at an angle of about 25 degrees to about 180 degrees.

In various embodiments, the cooling medium enters the flame reactor at cooling medium introduction angle of about 15 to about 30 degrees; from about 25 to about 40 degrees; from about 25 to about 90 degrees; from about 35 to about 50 degrees; from about 45 to about 60 degrees; from about 55 to about 70 degrees; from about 65 to about 80 degrees; from about 75 to about 90; from about 75 to about 120 degrees; from about 85 to about 100 degrees; from about 95 to about 115 degrees; from about 105 to about 120 degrees; from about 110 to about 150 degrees; from about 115 to about 135 degrees; from about 125 to about 140; from about 135 to about 150 degrees; from about 145 to about 160 degrees; from about 145 to about 180 degrees, from about 155 to about 170 degrees; or from about 165 to about 180 degrees. In another embodiment, the cooling medium enters the flame reactor at an angle of about 180 degrees; preferably at an angle of about 90 degrees; more preferably at an angle of about 45 degrees; and, most preferably, at an angle of about 25 degrees.

Another important factor is the angle at which the cooling medium contacts the flame 114, referred to herein as the flame contact angle (λ₁ and λ₂ of FIG. 2). Specifically, the flame contact angle is defined as the angle formed between the center axes of nozzles 206A and 206B (shown by broken lines 201A/201B), respectively, and the center axis (shown by broken line 209) of flame 114. The flame contact angle preferably is selected from any of the ranges of angles recited above with respect to the cooling medium introduction angles, which section is incorporated herein by reference as if it referred to the flame contact angle rather than the cooling medium introduction angle.

Additionally, the longitudinal placement of the nozzles 206A/206B, relative to flame 114, may play an important role in cooling the flame 114 in flame reactor 106. As shown, the cooling medium inlets 202A/202B may be located at a distance, δ, which is the longitudinal distance between burner outlet 205 to the cooling medium inlets 202A/202B, as shown in FIG. 2.

In another aspect, the placement of the a nozzle 206A/206B may be characterized by its flame-normalized nozzle placement parameter, defined herein as the ratio between a nozzle's longitudinal placement value (δ), as defined above, and the flame length (φ). As shown in FIG. 2, the term flame length (φ) is defined herein as the distance from burner outlet 205 and flame tip 210. In this aspect, the flame-normalized nozzle placement parameter preferably ranges from about 0 to about 100, e.g., from about 0.5 to about 10, from about 0.5 to about 100 or from about 0.5 to about 1.

The cooling medium introduction angles (θ₁ and θ₂), the flame contact angles (λ₁ and λ₂), the longitudinal placement value (δ), and the flame-normalized nozzle placement parameter may vary widely depending on how directly one wishes to contact the flame 114 with the cooling medium and a variety of other factors such as, but not limited to, the cooling ability of the cooling medium and the rate at which the cooling medium is introduced into the flame reactor 106. Thus, for example, the longitudinal placement value δ of a given nozzle may be varied such that, at a given cooling medium introduction angle θ, the cooling medium contacts the flame close to the burner 112. Alternatively, the longitudinal placement value δ of a given nozzle may be varied such that, at a given cooling medium introduction angle θ, the cooling medium contacts the flame close to the end of the flame that is distal from the burner.

When the cooling medium contacts the flame, the temperature of the flame will be decreased. The rate at which the flame contacts the cooling medium, as well as the nature of the cooling medium, will determine the rate at which the temperature of the flame will be decreased. In some embodiments, the cooling medium is introduced into the flame reactor at a rate of about 250 to about 1,000 standard liters per minute (SLPM); or at a rate of about 250 to about 500 SLPM; or at a rate of about 500 to about 750 SLPM; or at a rate of about 750 to about 1000 SLPM. In one embodiment, the flame is contacted with the cooling medium intermittently, while in another embodiment, the flame is contacted With the cooling medium continuously. Intermittent introduction of the cooling medium may desirable when the process temperature is to be maintained below a certain limit which is determined by materials of construction limitations or by the product particles. Intermittent introduction of the cooling medium is advantageous because it reduces the total volume of off gas that must be used in the process. Continuous cooling is desirable when the process temperature is to be maintained constant over an extended period of time, e.g., to produce particles with constant specific surface area.

In one embodiment, the cooling medium contacts the flame such that the temperature of the flame is decreased at a rate of 1,000° C. per second to about 5,000° C. per second; or at a rate of about 2,500° C. per second to about 7,500° C. per second; or at a rate of 5,000° C. per second to about 10,000° C. per second. In another embodiment, the cooling medium contacts the flame such that the temperature of the flame is decreased at a rate of at least 1,000° C. per second; preferably at a rate of at least 5,000° C. per second; most preferably at a rate of at least 10,000° C. per second. In still another embodiment, the cooling medium contacts the flame such that the temperature of the flame is decreased at a rate of about 1,000° C. per second to about 10,000° C. per second, optionally at a rate of 2500° C. per second to about 7500° C. per second, optionally at a rate of about 5000° C. to about 10,000° C. per second. These rates are based on the difference in temperature of the flame just prior to contacting the flame with the cooling medium and the temperature of the flame after contacting the flame with the cooling medium. In some embodiments, the adiabatic flame temperature of the flame is greater than 2000° C., in some cases greater than 2500° C. and in some cases greater than 3000° C.

In still another embodiment, the cooling medium contacts the flame such that the temperature of the flame is decreased at a rate of about 1,000° C. per second; or at a rate of about 5,000° C. per second; or at a rate of about 10,000C per second.

In yet another embodiment, the invention provides a process for decreasing flame temperature in a flame reactor, the process comprising the step of decreasing the flame temperature at a rate of about 900° C. per second to about 10,000° C. per second by contacting said flame with a cooling medium.

One might be inclined to decrease the temperature of the flame at a high rate when producing very small primary particles with very high specific surface area or when producing amorphous, rather than crystalline particles. In some embodiments, a slow cooling step may be followed by a rapid cooling step when a certain crystalline phase of the material is to be achieved without causing particle growth. In contrast, one might be inclined to decrease the temperature of the flame at a slow rate when producing large, unagglomerated spherical particles with low surface are or when producing highly crystalline particles.

Desirably, the flame spray processes of the present invention, and particularly the flame spraying steps thereof, occur in an enclosed flame spray system. As used herein, an “enclosed” flame spray system is a flame spray system that separates the flame from the surroundings and enables controlled input of, e.g., fuel/oxidant, nongaseous precursors and liquid vehicle, such that the process is metered and is precisely controlled.

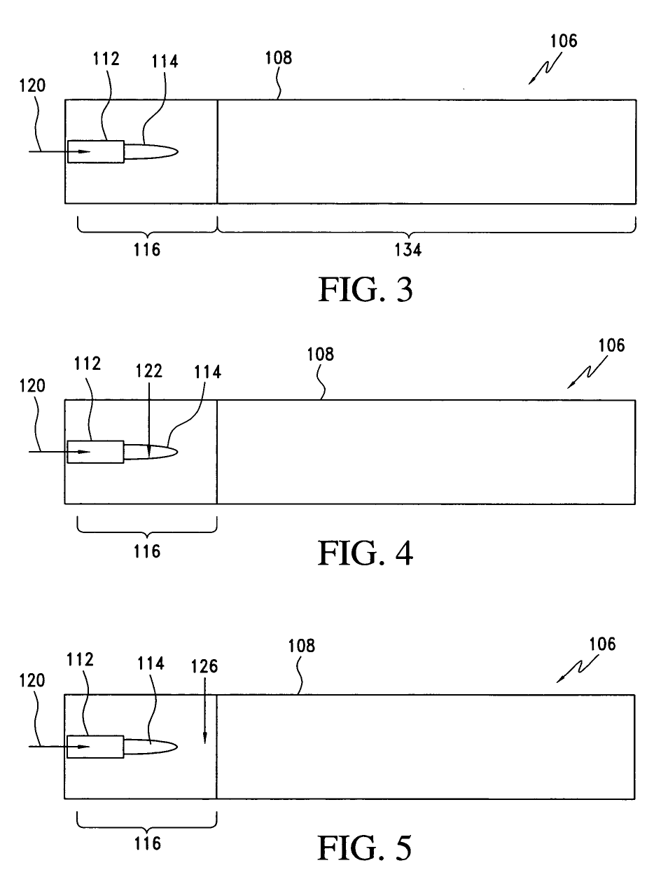

With reference to FIG. 3, one embodiment of a flame reactor that may be used with the method of the present invention is shown. FIG. 3 is a cross-sectional view of a flame reactor 106. Flame reactor 106 includes a tubular conduit 108 of a circular cross-section, a burner 112, and a flame 114 generated by the burner 112. In the embodiment of FIG. 3, flame 114 is disposed within tubular conduit 108. Flame reactor 106 has a very hot primary zone 116 that includes the flame 114 and the internal reactor volume within the immediate vicinity of the flame.

Also, shown in FIG. 3, feed 120, which includes the precursor medium, is introduced directly into the flame 114 through the burner 112. Fuel and oxidant for the flame 114 may be fed to the flame 114 as part of and/or separate from the feed 120 of the nongaseous precursor. In a preferred embodiment, the liquid vehicle preferably present in the precursor medium acts as the fuel.

FIGS. 4 and 5 show the same flame reactor 106, except with feed of the nongaseous precursor introduced into the primary zone 116 in different locations. In FIG. 4, feed of nongaseous precursor 122 is introduced in the primary zone 116 directed toward the end of the flame 114, rather than through the burner 112 as with FIG. 3. In FIG. 5, feed of nongaseous precursor 126 is introduced into the primary zone 116 at a location adjacent to, but just beyond the end of the flame 114.

FIGS. 3-5 are only examples of how precursor mediums may be introduced into a flame reactor. Additionally, multiple feeds of precursor medium may be introduced into the flame reactor 106, with different feeds being introduced at different locations, such as simultaneous introduction of the feeds 120, 122 and 126 of FIGS. 3-5.

To form the desired product particles (e.g., nanoparticles), which include the component from the nongaseous precursor in the precursor medium, the component is transferred through the gas phase in the flowing stream in the flame reactor. Following nucleation of the particles, the particles then grow to the desired size by coagulation and coalescence.

During the step of transferring of the component through the gas phase, the component of the nongaseous precursor, and optionally all other material (if any) of the nongaseous precursor, enters the gas phase in a vapor form. The transfer into the gas phase is driven by the high temperature in the flame reactor in the vicinity of where the nongaseous precursor is introduced into the flame reactor. As previously noted, this may occur by any mechanism which may include simple vaporization of the nongaseous precursor or thermal decomposition or other reaction involving the nongaseous precursor. The transferring step also includes removing the component from the gas phase, to permit inclusion in the nanoparticles. Removal of the nongaseous precursor from the gas phase may likewise involve a variety of mechanisms, including simple condensation as the temperature of the flowing stream drops, or a reaction producing a non-volatile reaction product. Also, it is noted that transfer into and out of the gas phase are not necessarily distinct steps, but may be occurring simultaneously, so that some of the component may still be transferring into the gas phase where other of the component is already transferring out of the gas phase. Regardless of mechanism, however, substantially all of the component from the nongaseous precursor is transferred through the gas phase.

In one aspect, the nongaseous precursor may be a solid material that includes the component. The temperature in the flame reactor may be above the boiling point or sublimation temperature of the solid material. Consequently, the transferring of the component through the gas phase may involve simple vaporization of liquid medium in order to cause the solid material to flow through the flame reactor. Examples include AlCl₃ and ZrCl₄; both solids at room temperature but with relatively high vapor pressure and low sublimation temperatures (<300° C.). Additionally or alternatively, the transferring of the component through the gas phase may involve simple vaporization of a solid nongaseous precursor in order to cause the solid material to flow through the flame reactor. In one specific example, the precursor may be a solid or liquid metal or metal oxide, and the metal is the component for inclusion in the nanoparticles. In the flame reactor, the metal (metal oxide) may then vaporize in the high temperature zone of the flame reactor following introduction and then condense out as the stream cools. The temperature in the flame reactor may be above the boiling point of metal or metal oxide, so that the-metal introduced as a solid in the flowing stream will boil and be included if the gas phase as metal vapor, prior to being included in the nanoparticles. Thus, the transferring step may merely involve boiling or vaporizing a solid precursor into a vapor. In another example, a solid or liquid precursor including the component may react or decompose to form a reaction product, either a vapor-phase material or one that is vaporized following formation.

Also, substantially all material in a feed stream of the nongaseous precursor should in one way or another be transferred into the gas phase during the transferring step. For example, one common situation is for the feed to include droplets in which the nongaseous precursor is dissolved when introduced into the flame reactor. In this situation, liquid in the droplet must be removed as well. The liquid may simply be vaporized to the gas phase, which would be the case for water. Also, some or all of the liquid may be reacted to vapor phase products. As one example, when the liquid contains fuel or oxidant that is consumed by combustion in a flame in the reactor, any solid fuel or oxidant in the feed may also be consumed and converted to gaseous combustion products. In some cases, however, the particles, when present, will not be transferred into the gas phase.

As indicated above, the particles formed during the transferring step may be grown to a desired size and morphology through controlled agglomeration. During the growing step, the nanoparticles are controllably grown to increase the weight average particle size of the nanoparticles into a desired weight average particle size range, which will depend upon the particular composition of the nanoparticles and the particular application for which the nanoparticles are being made.

The growing step commences with particle nucleation and continues until the nanoparticles attain a weight average primary particle size within a desired range. When making extremely small particles, the growing step may mostly or entirely occur within the primary zone of the flame reactor immediately after the flame. However, when larger particle sizes are desired, processing may be required in addition to that occurring in the primary zone of the flame reactor. As used herein, “growing” the nanoparticles refers to increasing the weight average particle size of the nanoparticles. Such growth may occur due to collision and agglomeration and sintering of smaller particles into larger particles or through addition of additional material into the flame reactor for addition to the growing nanoparticles. The growth of the nanoparticles may involve added material of the same type as that already present in the nanoparticles or addition of a different material. Depending on the temperature and the residence time in the primary zone of the reactor, the particles may completely fuse upon coagulation to form individual spheres on the order of 50 nm to 200 nm, or they can partially fuse to form hard fractal-like aggregates.

As noted, in some embodiments an important contribution to the growing step is due to collisions between similar particles and agglomeration of the colliding particles to form a larger particle. The agglomeration (coagulation) preferably is complete that the colliding particles fuse together to form a new larger primary particle, with the prior primary particles of the colliding particles no longer being present. Agglomeration (coagulation) to this extent will often involve significant sintering to fuse the colliding particles. An important aspect of the growing step within the flame reactor is to control conditions within the flame reactor to promote the desired collision and fusing of particles following nucleation. Control of the coagulation and sintering (coalescence) rates controls the final product particle size and morphology (e.g., spherical particles versus aggregates).

In other embodiments, the growing step may occur or be aided by adding additional material to the nanoparticles following nucleation. In this situation, the conditions of the flame reactor are controlled so that the additional material, and optionally energy, is added to the nanoparticles to increase the weight average particle size of the nanoparticles into the desired range. Growth through addition of additional material and surface reaction of the latter on the already formed particles are described in more detail below. In some embodiments, the growing step may involve both collision/agglomeration and material additions.

In one embodiment, during the growing step, the primary particles grow to a weight average particle size (d50 value) in a range selected from the group consisting of 1 nm, 5 nm, 10 nm, 20 nm, and 40 nm. In one embodiment, during the growing step, the product particles (product nanoparticles or agglomerates) grow to a weight average particle size (d50 value) in a range having a lower limit selected from the group consisting of 50 nm, 60 nm, 70 nm, 80 nm, 90 nm, 100 nm, 125 nm and 150 nm and an upper limit selected from the group consisting of 10 nm, 20 nm, 30 nm, 40 nm, 50 nm, 60 nm, 70 nm, 80 nm, 90 nm, 100 nm, 125 nm, 150 nm, 200 nm, 250 nm, 300 nm, 400 nm and 500 nm; provided that the upper limit is selected to be larger than the lower limit.

One particularly desirable aspect of the invention is the ability to form a population of nanoparticles, as formed, having a narrow distribution of particles. The narrow particle size distributions made possible by the present invention may be characterized by the standard deviation of the population of nanoparticles. In various aspects, the population of nanoparticles, as formed, has a standard deviation less than about 2.2, less than about 2.0, less than about 1.8, less than about 1.6, less than about 1.4, less than about 1.3 or less than about 1.2.

In one aspect, a majority of the nanoparticles formed by the processes of the present invention comprises a primary aggregation of primary nanoparticles. Especially when making larger nanoparticles it is important to provide sufficient residence time at sufficiently high temperature to permit the desired particle growth. These larger-size nanoparticles are desirable for many applications, because the larger-size nanoparticles are often easier to handle, easier to disperse for use and more readily accommodated in existing product manufacturing operations. By larger-size nanoparticles it is meant those having a weight average particle size of at least 50 nm, at least 70 nm or at least 100 nm or even larger (e.g., about 1 micron). Growing nanoparticles to those larger sizes will, in some cases, require a controlled secondary zone in the flame reactor, because the particle size attainable in the primary zone is may be much smaller than the desired size. Also, it is important to emphasize that the size of the nanoparticles as used herein refer to the primary particle size of individual nanoparticulate domains, and should not be confused with the size of aggregate units of necked-together primary particles. Unless otherwise specifically noted, particle size herein refers only to the size of the identifiable primary particles.

In one aspect, the methods of the present invention involve making relatively large-size nanoparticles having a relatively low-melting temperature material. The low-melting temperature material preferably has a melting temperature that is less than about 2000° C. In some embodiments, the low-melting temperature material may have a melting temperature within a range having a lower limit selected from the group consisting of 200° C., 300° C., 400° C., 500° C., 600° C., 700° C., 800° C. and 900° C. and an upper limit selected form the group consisting of 2000° C., 1900° C., 1800° C., 1700° C., 1600° C., 1500° C., 1400° C., 1300° C., 1200° C., 1100° C. and 1000° C. The nanoparticles may be made entirely of the low-melting temperature material or the low-melting temperature material may be one of multiple phases when the nanoparticles are multi-phase nanoparticles. The low-melting temperature materials may be metal or ceramic and may be organic or inorganic, although inorganic materials are generally preferred. Some examples of metals that are low-melting temperature materials that may be processed with this implementation of the invention (and their melting temperatures) include: silver, gold, copper, nickel, chromium, zinc, antimony, barium, cesium, cobalt, gallium, germanium, iron, lanthanum, magnesium, manganese, palladium, platinum, uranium, strontium, thorium, titanium and yttrium and alloys (including intermetallic compounds) of any number of the foregoing. Other metal alloys (including intermetallic compounds) including a metal component with a higher melting temperature may nevertheless also have melting temperatures applicable for processing according to this implementation of the invention (e.g., including many eutectic compositions). Some examples of ceramics that are low-melting temperature materials and may be processed with this implementation of the invention include: some oxides, such as tin oxides, indium tin oxide, antimony tin oxide and molybdenum oxides; some sulfides, such as zinc sulfide; and some silicates, such as borosilicate glasses. Also, a number of metal alloys and intermetallic compositions including one or more of these metals have low melting temperatures and are processible with this implementation of the invention.

At least a portion of the growing step will optionally be performed in a volume of a flame reactor downstream from the primary zone that is better suited for controllably growing nanoparticles to within the desired weight average particle size range. This downstream portion of the flame reactor is referred to herein as a secondary zone to conveniently distinguish it from the primary zone discussed above.

FIG. 3, discussed above, shows an embodiment of flame reactor 106 having a secondary zone 134 for aiding growth of the nanoparticles to attain a weight average particle size within the desired range. As shown in FIG. 3, the secondary zone is a volume within conduit 108 that is downstream from the primary zone 116. The secondary zone 134 will optionally be longer and occupy more of the internal reactor volume than the primary zone 116, and the residence time in the secondary zone 134 may be significantly larger than in the primary zone 116.

Optionally, an insulating material, not shown, surrounds and insulates the portion of the conduit 108 that includes the secondary zone 134. Additionally or alternatively, the secondary zone, or a portion thereof, is surrounded by a heater, not shown. The heater is used to input heat into the flowing stream while the flowing stream is within the secondary zone. The additional heat added to the secondary zone 134 by the heater, provides control to maintain the nanoparticles at an elevated temperature in the secondary zone that is higher than would be the case if the heater were not used. The heater may be any device or combination of devices that provides heat to the flowing stream in the secondary zone. For example, the heater may include one or more flames or may be heated by a flame or a circulating heat transfer fluid. In one embodiment, the heater includes independently controllable heating zones along the length of the secondary zone 134, so that different subzones within the secondary zone 134 may be heated independently. This could be the case for example, when the secondary zone is a hot wall tubular furnace including multiple independently controllable heating zones.

The embodiment of flame reactor 106 shown in FIG. 3 is merely one example of a flame reactor for use with performing the method of the present invention. In other embodiments, the primary zone and the secondary zone may be within different conduit configurations or within different equipment or apparatus in fluid communication. Additionally, as further described below, the primary zone and the secondary zone may be separated by other processing zones such as a quench zone and/or a particle modifying zone, described in more detail below.

The following is a description of how the method of one aspect of the invention may be performed using the flame reactor 106 shown in FIG. 3. During the introducing step, feed 120 of a precursor medium comprising a nongaseous precursor is introduced into primary zone 116 through burner 112. Oxidant and a fuel are also fed to the flame through burner 112 for combustion to maintain the flame 114. The oxidant and/or fuel may be fed to the burner 112 together with or separate from the feed of the nongaseous precursor 120. In the primary zone, the physicochemical phenomena that take place are in the following order: droplet evaporation, combustion of liquid vehicle and/or precursor, precursor reaction/decomposition, particle formation via nucleation, and particle growth by coagulation and sintering. Particle growth continues into the secondary zone. The temperature attained in the primary zone 116 preferably is sufficiently high so that substantially all material of the target component in the nongaseous precursor is transferred through the gas phase, and nucleation at least begins in primary zone 116. As the flowing stream in the flame reactor 106 exits the primary zone 116 and enters secondary zone 134, the nanoparticles are growing. In secondary zone 134, conditions are maintained that promote continued growth of the nanoparticles to a large- size within the desired weight average particle size range.

As noted previously, the residence time in the secondary zone may be longer than the residence time in the primary, or hot zone. By the term “residence time” it is meant the length of time that the flowing stream, remains within a particular zone (e.g., primary zone or secondary zone) based on the average stream velocity through the zone and the geometry of the zone.

In one embodiment, the residence time within the primary zone is less than one second, and optionally significantly less. Often the flowing stream has a residence time in the primary zone (and also the flame) in a range having a lower limit selected from the group consisting of 1 ms, 10 ms, 100 ms, and 250 ms and an upper limit selected from the group consisting of 500 ms, 400 ms, 300 ms, 200 ms and 100 ms, provided that the upper limit is selected to be larger than the lower limit. In some embodiments, the residence time within the secondary zone is at least twice as long, four times as long, six times or ten times as long as the residence time in the primary zone (and also as the residence time in the flame). Often, the residence time in the secondary zone is at least an order of magnitude longer than the residence time in the primary zone. The residence time of the flowing stream in the secondary zone is often in a range having a lower limit selected from the group consisting of 50 ms, 100 ms, 500 ms, 1 second and 2 seconds and an upper limit selected from the group consisting of 1 second, 2 seconds, 3 seconds, 5 seconds and 10 seconds, provided that the upper limit is selected to be larger than the lower limit. In the foregoing discussion, it should be understood that the residence times discussed above with respect to the flowing stream through the secondary zone would also be the residence time of the nanoparticles in the secondary zone, since the nanoparticles are within the flowing stream. In some embodiments, the total residence for both the primary zone and the secondary zone is in a range having a lower limit selected from the group consisting of 100 ms, 200 ms, 300 ms, 500 ms and 1 second and an upper limit selected from the group consisting of 1 second, 2 seconds, 3 seconds, 5 seconds and 10 seconds, provided that the upper limit is selected to be larger than the lower limit.

In determining an appropriate residence time of the nanoparticles in the secondary zone there are several considerations. Some of the considerations include the desired weight average particle size, the melting temperature (and sintering temperature) of materials in the nanoparticles, the temperature within the secondary zone, residence time in the secondary zone and the number concentration of the nanoparticulates in the flowing stream (i.e., number of nanoparticles per unit volume of the flowing stream).

With respect to the number concentration of nanoparticles flowing through the secondary zone, if such number concentration is sufficiently large, then the nanoparticles will tend to collide more frequently providing greater opportunity for particle growth more quickly, requiring less residence time within the secondary zone to achieve a desired weight average particle size. Conversely, if the nanoparticulate concentration within the secondary zone is small, the collisions between nanoparticles will be less frequent and particle growth will necessarily proceed more slowly. Moreover, there is a particular number concentration of nanoparticles, referred to herein as a “characteristic number concentration,” below which particle collisions become so infrequent that for practical purposes the nanoparticles effectively stop growing due to particle collisions. Another way of describing the characteristic number concentration of nanoparticles is that it is the minimum number concentration of nanoparticles in the secondary zone that is necessary from a practical perspective to achieve a particular weight average particle size for the nanoparticles through collisions in a residence time that is reasonably practical for implementation in a flame reactor system. The characteristic number concentration will be different for different weight average particle sizes.

If the temperature within the secondary zone is set to promote the growth of the nanoparticles through collisions of the nanoparticles (i.e. high enough for colliding particles to fuse to form a single nanoparticulate), then control of the number concentration of the nanoparticles and residence time in the secondary zone are two important control variables. Thus, if the number concentration of nanoparticles in the secondary zone is maintained at a specific concentration, then the residence time within the secondary zone will be changed in order to achieve the desired extent of collisions to achieve a weight average particle size in a desired range. However, if the residence time is set, then the number concentration of nanoparticles within the secondary zone may be controlled so that the desired weight average particle size is achieved within the set residence time. Control of the weight average particle size may be achieved for example by changing the temperature in the secondary zone and changing the concentration of the precursor in feed to the primary zone, or a combination of the two, or by changing the reactor cross-sectional area and/or the cross-sectional area of the flame at its broadest point. In one embodiment, the ratio of the cross-sectional area of the flame at its broadest point and the cross-sectional area of the reactor at that same point is preferably 0.01 to 0.25. Conversely, for a set residence time and temperature profile in the secondary zone, the concentration of nongaseous precursors (and other precursors) fed to the primary zone may be adjusted to achieve a desired volume concentration in the secondary zone to achieve at least the characteristic volume concentration for a desired weight average particle size.

Temperature control in the secondary zone of the flame reactor is very important. Maintaining the temperature of the secondary zone within a specific elevated temperature range may include retaining heat already present in the flowing stream (e.g., residual heat from the flame in the primary zone). This may be accomplished, for example, by insulating all or a portion of the conduit through the secondary zone to reduce heat losses and retain a higher temperature through the secondary zone. In addition to or instead of insulating the secondary zone, heat may be added to the secondary zone to maintain the desired temperature profile in the secondary zone.

The temperature in the secondary zone is maintained below a temperature at which materials of the nanoparticles would vaporize or thermally decompose, but above a sintering temperature of the nanoparticles. By “sintering temperature” it is meant a minimum temperature, at which colliding nanoparticles sticking together will fuse to form a new primary particle within the residence time of the secondary zone. The sintering temperature of the nanoparticles will, therefore, depend upon the material(s) in the nanoparticles and the residence time of the nanoparticles in the secondary zone as well as the size of the nanoparticles. In those embodiments where the growing of the nanoparticles includes significant growth through particle collisions, the nanoparticles should be maintained at, and preferably above, the sintering temperature in the secondary zone.

When the nanoparticles are multi-phase particles, the “sintering temperature” of the nanoparticles will vary depending upon the materials involved and their relative concentrations. In some cases, the sintering together will be dictated by the lowest melting temperature material so long as that material is sufficiently exposed at the surface of colliding particles to permit the low-melting temperature domains to fuse to an extent to result in a new primary particle through the action of the lower-melting temperature material.

In a variation of the present invention, the nanoparticles are maintained through at least a portion of, and perhaps the entire secondary zone, at or above a melting temperature of at least one material in the nanoparticles, promoting rapid fusing and formation of a new primary particle. In another variation, the nanoparticles are maintained, through at least a portion of and perhaps the entire secondary zone, at a temperature that is within some range above or below the melting temperature of at least one material of the nanoparticles. For example, the temperature of the flowing stream through at least a portion of the secondary zone may be within a temperature range having a lower limit selected from the group consisting of 300° C. above the melting temperature of the material, 200° C. above the melting temperature of the material and 100° C. above the melting temperature and having a lower limit selected from the group consisting of 300° C. below the melting temperature of the material, 200° C. below the melting temperature of the material and 100° C. below the melting temperature of the material, provided that the upper limit must be selected to be below a vaporization temperature of the material and below a decomposition temperature of the material where the material decomposes prior to vaporizing. In a further variation, the temperature of the flowing stream in the secondary zone does not exceed a temperature within the selected range. As used herein, the temperature in the secondary zone and the stream temperature in the secondary zone are used interchangeably and refer to the temperature in the stream in the central portion of a cross-section of the conduit. As will be appreciated, the flowing stream will have a temperature profile across a cross-section of the flow at any point, with the temperature at the edges being higher or lower than in the center of the stream depending upon whether there is heat transfer into or out of the conduit through the wall.

In some embodiments, the growing step includes adding additional material to the nanoparticles (other than by collision/agglomeration) to increase the weight average particle size into a desired size range. The additional material may be the same or different than the material resulting from the nongaseous precursor discussed above.

When the additional material includes the same component as the component provided by the nongaseous precursor, discussed above, the additional amount of the component added to the nanoparticles may be derived from addition of more of the nongaseous precursor or from a different precursor or precursors. Moreover, the additional material added to the nanoparticles may result from additional precursor or precursors introduced into the flame reactor separate in the primary zone and/or the secondary zone.

An additional precursor may be included into the flame reactor during the introducing step as part of a combined feed with the nongaseous precursor, discussed above, when the additional precursor is different than such nongaseous precursor. Alternatively, additional precursors may be introduced separately into the flame reactor into the primary and/or secondary zone.

The following includes a description of various embodiments of the present invention in which one or more than one additional precursor is added to the flame reactor.

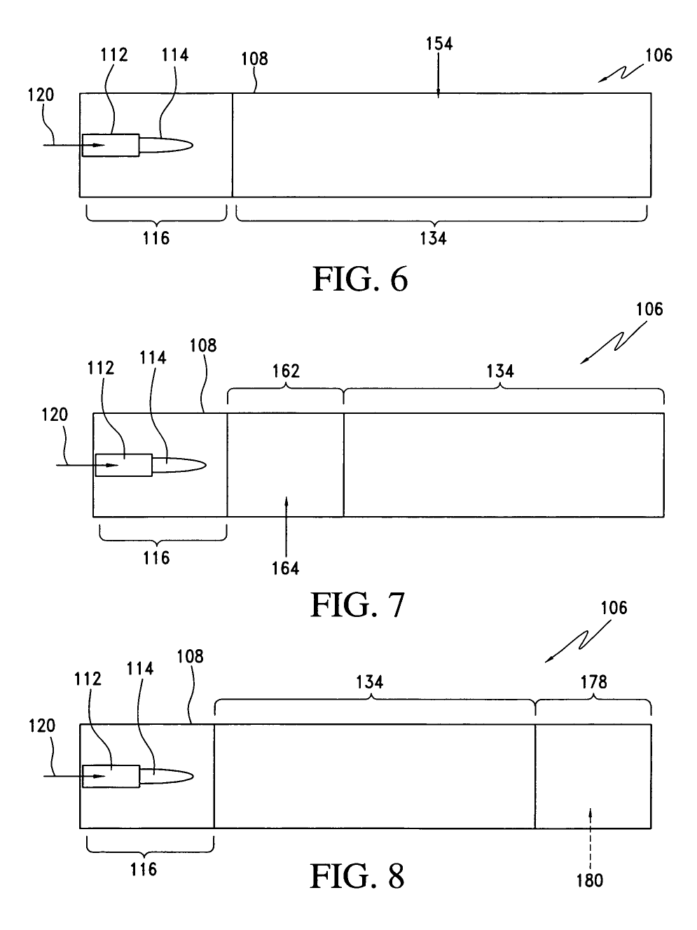

FIG. 6 shows an embodiment of flame reactor 106 that includes a feed 154 introduced into the secondary zone 134. Feed 154 includes a precursor or precursors for material for growth of the nanoparticles in the secondary zone during the step of growing the nanoparticles. The feed 154 may include liquids, solids, gases and combinations thereof. Each precursor in feed 154 may be in the form of a liquid (including a solute in a liquid) a solid, or a gas. For example, a precursor in feed 154 may be a liquid phase precursor (e.g., a liquid substance or dissolved in a liquid). The liquid precursor may be introduced into secondary zone 134 in disperse droplets. As another example, a precursor may be a solid precursor which may be introduced into the secondary zone 134 in the feed 154 as dry disperse particulates or particulates contained in droplets. In another example, a precursor may be gaseous and included in a gas phase of feed 154.

The feed 154 and precursor(s) contained therein may be introduced into secondary zone 134 in a variety of ways. For example, if the precursor is contained in a liquid or a solid, it may be introduced into the secondary zone 134 in a disperse phase (e.g., droplets or particles) dispersed in a gas phase of feed 154. In other cases, feed 154 may only include the precursor in a liquid or a solid form with no additional phases or materials (i.e., feed 154 may be liquid sprayed into the secondary zone or a solid particulate feed into the secondary zone 134 without the aid of a gas phase).

In one variation, feed 154 may be introduced into the secondary zone 134 through a burner and a flame generated by that burner. The heat from the flame may be used to vaporize or otherwise react a precursor in feed 154 as may be necessary for forming the material to promote growth of the nanoparticles in the secondary zone 134.

The introduction of feed 154 into secondary zone 134 may occur at various locations within the secondary zone 134, rather than at only one location as shown in FIG. 6. The invention is not limited to introduction of a single feed as shown in FIG. 6. Different ones of a plurality (i.e., more than one) of feeds may be introduced at different locations along the secondary zone 134, and the different feeds need not be of the same composition or include the same precursor(s). For example, a feed may be introduced at the beginning of secondary zone 134 and another feed of additional material may be introduced near the middle of secondary zone 134. In another example, several feeds may be at spaced locations along the secondary zone 134. The invention is not limited to these variations, and other variations are possible.

Different feeds that may be introduced into the secondary zone 134 do not have to include precursor(s) to the same materials or materials for inclusion in the nanoparticles. Precursor(s) to different materials in differed spaced feeds may be desirable, for example, to form sequences of layers of different materials on the nanoparticles.

In one implementation of the embodiment of the present invention utilizing the flame reactor 106 shown in FIG. 6, feed 154 has a precursor to an additional material that is different than any material already contained in the nanoparticles when the nanoparticles exit the primary zone 116. This implementation may be useful for making nanoparticles including two or more different materials that are preferably formed under different processing conditions. This embodiment is also useful for making multi-phase nanoparticles when a particular morphology is desired. For example, the additional material added to the nanoparticles in the secondary zone may form a coating on the nanoparticulates to form nanoparticles with a core/shell morphology or it may decorate the surface of the support particles with nanoparticles. The additional material may also react to form particles that are segregated from the particles produced in the primary zone, thus resulting in a mixture of two or more different types of particles in the product particles.

In one particularly preferred embodiment, the present invention is directed to a flame spray process for forming product particles, preferably nanoparticles, and optionally composite nanoparticles. By “composite particles” it is meant particles formed of a plurality of materials, e.g., particles having a homogenous mixture of two or more materials or particles having a core/shell structure. By “core/shell structure,” it is meant that the composite particles comprise: (1) a core comprising a first material; and (2) a shell partially or totally surrounding the core and comprising a second material. For example: core/shell may mean core particle that is decorated by finer nanoparticles of a second component. It may also mean a composite particle that has distinct regions with different components incorporated within each region.

Thus, in one aspect, the present invention is directed to a flame spray process for forming product particles, e.g., composite particles, having a core/shell structure. The composite particles formed by the processes may also comprise a coating of the component on the support particles. Coating thickness may vary from 1 nm to 10 nm. The thickness of the coating is controlled, for example, by the concentration ratio of the nongaseous precursor to the support particle concentration, the flame temperature, and the level of mixing within the first liquid vehicle.

Depending on the conditions in the flame spray reactor, the composite particles may comprise a population of nanoparticles comprising the component on the support particles rather than a coating. The nanoparticles may have any of the characteristics, e.g., particle size, described above. The population of nanoparticles optionally has a d95 less than about 200 nm.

The support particles optionally have an average particle size of less than about 10 μm, e.g., less than about 5 μm or less than about 1 μm. The support particles optionally comprise a material selected from the group consisting of: a metal, a metal oxide, a metal salt, a nitride, a carbide, a sulfide and carbon.

In this aspect of the invention, at least 90 weight percent, at least about 95 weight percent or at least about 97 weight percent of the nongaseous precursor to the component in the first precursor medium is converted to the component.

In one variation, the different material formed and deposited on the nanoparticles in the second zone aids growth of the nanoparticles through enhancement of the sinterability of colliding nanoparticles. The different material added to the nanoparticles may have, for example, a lower sintering and/or melting temperature than other material(s) in the nanoparticles, and addition of this additional material on the exposed surface of the nanoparticles will assist colliding particles to stick together and fuse to form a new primary particle. This is particularly the case if the temperature in secondary zone 134 is maintained at a temperature above the melting temperature of the additional material. The presence of liquid phase material or other flux-like material exposed at the surface of the nanoparticles will significantly aid the prospect that colliding particles will join together and form a new primary particle. This embodiment is particularly useful for growing nanoparticles containing high-melting temperature material(s) that might not otherwise stick together and sufficiently sinter to form a new, larger primary aggregate.

When the growing step includes growing the nanoparticles through collisions, in one implementation the growth may be aided by the use of a fluxing material. By the term “fluxing material” or simply “flux”, which are used interchangeably herein, it is meant a material that promotes and aids in fusing, sintering or coalescing of two colliding nanoparticles to form a new primary particle larger in size than either of the two colliding nanoparticles. The previously described embodiment of adding an additional material to the nanoparticles in secondary zone 154 that is of a lower melting temperature than other materials in the nanoparticles is one example of the use of a fluxing material. However, the use of a fluxing material is not limited to that embodiment. For example, a fluxing material does not have to be a liquid or be in a liquid phase during the growing step in order to aid in growing the nanoparticles. In some cases, the fluxing material may be a solid phase.

The fluxing material may be introduced into the flame reactor at any convenient location as long as the introduction and subsequent processing results in exposure of the fluxing material at the surface of the nanoparticles through at least some portion of the secondary zone during the growing step. With reference to FIG. 3, as one example, the fluxing material may be introduced as part of the flowing stream during the step of introducing the precursor medium into primary zone 116. As another example, the fluxing material may be added into secondary zone 134, such as, for example, part of feed 154 into the secondary zone during the growing step. One advantage of introducing the fluxing material in feed 154 is the ability to controllably deposit the fluxing material on the outside of the nanoparticles. The fluxing material should be introduced in such a manner and/or be of such a type that the fluxing material deposits on the surface of already formed nanoparticles or through phase interaction in the nanoparticles migrates to the surface of the nanoparticles, so that it will be available at the surface of the nanoparticles to aid growth of colliding particles. The fluxing material does not, however, have to completely cover an outside surface of the nanoparticles, but only needs to be exposed at over a sufficient portion of the surface to provide the growth aiding effect to colliding particles.

High-melting temperature materials, which may be processed with use of a fluxing material include high-melting temperature metals and ceramics. The high-melting temperature material may have a melting temperature of at least as high as or higher than a temperature selected from the group consisting of 1800° C., 1900° C., 2000° C., and 2200° C., but generally lower than 3000° C. or even lower than 2500° C. Some examples of metals that may be considered high-melting temperature materials include boron, chromium, hafnium, iridium, molybdenum, niobium, osmium, rhenium, ruthenium, tantalum, tungsten and zirconium. Some classes of ceramics that include materials that may be considered as being high-melting temperature materials include oxides, nitrides, carbides, tellurides, selenides, titanates, tantalates and glasses.

The product particles ultimately formed according to the present invention optionally comprise primary particles. By “primary particles,” it is meant identifiable particulate domains that are either substantially unagglomerated (i.e., substantially unattached to each other) or if agglomerated never the less retain the identifiable particulate attributes, in that the particulate domains are joined together through necking between the still identifiable separate particulate domains. In some embodiments of the invention, the product particles are substantially unagglomerated, while in other embodiments the nanoparticles may be in the form of aggregates which may be hard agglomerates (meaning that the agglomerates are not easy to break apart to release the individual nanoparticles). As will be appreciated, when the nanoparticles are in the form of aggregates, the aggregate units will be of a larger size than the nanoparticles. Such aggregate units may include only two nanoparticles or may comprise dozens or even hundreds or more of the nanoparticles. In most, but not all embodiments, it is preferred that the nanoparticles made according to a method of the invention are either substantially unagglomerated or in the form of soft agglomerates that are easily broken up.

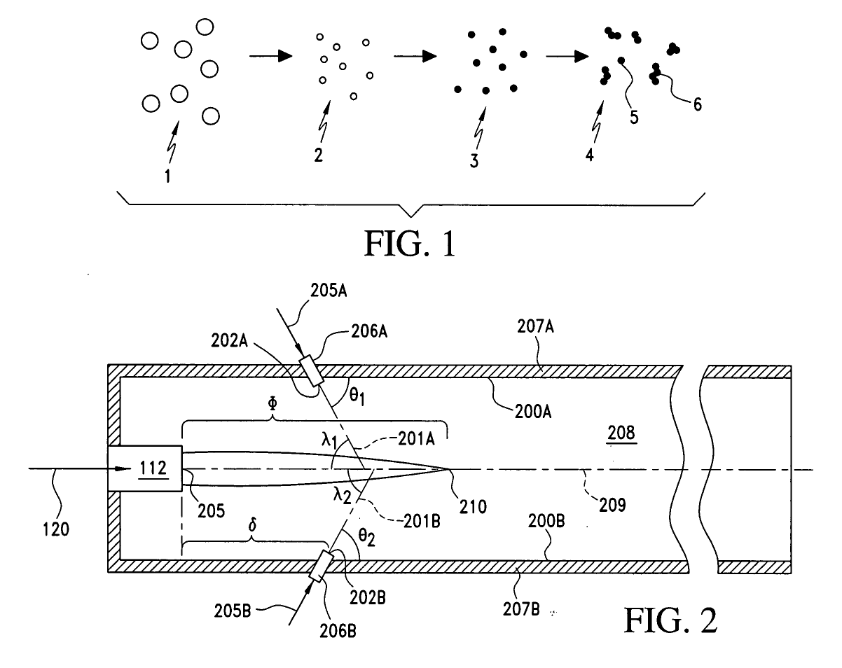

FIG. 1 illustrates one non-limiting example of how nanoparticles and aggregates of nanoparticles of a single phase may be formed during a flame spray process. As shown, droplets 1 comprising a nongaseous precursor to a component and optionally a liquid vehicle are formed in an atomization step. As the droplets 1 contact the flame in the flame reactor, the liquid vehicle vaporizes to form smaller droplets 2. The vaporized liquid vehicle and the precursor combust in the presence of oxygen. The combustion reaction generates enough heat to completely evaporate the droplets and vaporize the non-gaseous precursor. The vaporized nongaseous precursor reacts in the gas phase to form nanoparticles 3, which comprise the component. Alternatively, the vaporized nongaseous precursor reacts in the smaller droplets 2. As the nanoparticles 3 flow through the flame reactor they may agglomerate to form nanoparticles 4, where nanoparticles have grown to form product agglomerate particles 5 and/or that have agglomerated to form aggregate particles 6. Advantageously, the degree of aggregation can be controlled by carefully controlling the temperature of the nanoparticles 6 after they are formed. Generally, the further downstream the cooling step occurs, the larger the ultimately formed product particles will be. Conversely, cooling the nanoparticles 6 immediately after they are formed, e.g., with a quench medium, will reduce aggregate particle formation. If aggregates are desired, then the cooling should occur downstream in the reactor to allow the nanoparticles to agglomerate.

In a preferred aspect of the invention, the product particles comprise multi-phase particles. The different phases of the multi-phase particles may be distributed within the product particles in any of a variety of morphologies. For example, two or more of the phases may be intimately mixed together, or one or more phases may form a core phase surrounded by a shell of one or more other phases that form a shell (or covering) about the core, or one or more phases may be in the form of a dispersion dispersed in a matrix comprised of one or more other phases. Such multi-phase nanoparticles include at least two phases, but may include three, four or even more than four phases.

In one preferred embodiment, the product particles, e.g., product nanoparticles, made with the method of the present invention are spheroidal. By the term “spheroidal” it is meant a shape that is either spherical or resembles a sphere even if not perfectly spherical. For example such spheroidal product particles, although of rounded form, may be elongated or oblong in shape relative to a true sphere. As another example, such spheroidal product particles may have faceted or irregular surfaces other than the rounded surfaces of a sphere. Also, the product particles may have significant internal porosity or may be very dense, with particles of higher density generally being preferred. In one implementation, the product particles have a density of at least 80 percent, or at least 85 percent or even at least 90 percent of theoretical density for the composition of the product particles, as measured by helium pyconometry or other density measurements. In some applications, however, it may be desirable to have very high specific surface area, and the product particles may include a significant amount of porosity.

The product particles formed by the process of the present invention may be suitable for a variety of applications. Depending upon the final application, the product particles may be made with a wide variety of compositions and other properties. For example, the product particles may be transparent (such as for use in display applications), electrically conductive (such as for use in electronic conductor applications), electrically insulative (such as for use in resistor applications), thermally conductive (such as for use in heat transfer applications), thermally insulative (such as for use in a heat barrier application) or catalytically active (such as for use in catalysts applications). In one example, the process of the present invention may be used to produce heterogeneous catalysts comprising an active catalytic component/phase dispersed on a high surface area support/carrier, optionally together with a promoter component. Non-limiting examples of promoter components include metal oxides or alkaline earth metals (e.g., CeO₂, elemental sodium and elemental potassium). In one capacity, the promoter component serves to increase the activity or stability of the active catalytic component/phase. In another capacity, the promoter component may serve to improve dispersion of the active catalytic component/phase. Some examples of catalytically active components/phases include noble metals (e.g., Pt, Pd, Rh, etc.), base metals (e.g., Ni, Co, Mo, etc.), metal oxides (e.g., CuO, MoO₂, Cr₂O₃, Fe₂O₃, etc.) or metal sulfides (e.g., MoS₂, Ni₃S₂, etc.). Some examples of support/carriers include carbon, aluminum oxide, silicon dioxide, zirconium oxide, cerium oxide, titanium oxide, etc. Other nonlimiting examples of possible properties of the product particles for use in other applications include: semiconductive, luminescent, magnetic, electrochromic, capacitive, bio-reactive and bio-ceramic.

Table 1 lists some nonlimiting examples of materials that may be included in the product particles made with various implementations of the method of the present invention. Table 1 also lists some exemplary applications for product particles that may include the listed materials. Other nonlimiting examples of materials that may be included in the product particles made with various implementations of the method of the present inventions are each and every one of the materials disclosed for inclusion in nanoparticles in U.S. patent application Ser. Nos. 11/117,701, filed Apr. 29, 2005; 11/199,512, filed Aug. 8, 2005; and 11/199,100, filed Aug. 8, 2005, the entireties of which are incorporated herein by reference.

TABLE 1

| Product Particle | | |
|---|---|---|
| Material | Example Formula | Exemplary Applications |
| Simple Oxides | | |
| Alumina | Al₂O₃ | Chemical Mechanical |
| | | Planarization (CMP), |
| | | Catalysis |
| Magnesia | MgO | CMP |
| Ceria | CeO₂ | Catalysis, Optics, CMP |
| Zirconia | ZrO₂ | CMP, Catalysis |
| Titania | TiO₂ | Pigments, Catalysis |
| Titanium suboxide | TiO | Pigments |
| Silica | SiO₂ | Ceramics |
| Iron oxides | Fe₂O₃, Fe₃O₄ | Electronics, recording |
| | | media |
| Zinc Oxide | ZnO | Electronics, recording |
| | | media |
| Tin oxide | SnO | Electronics, recording |
| | | media |
| Bismuth oxide | Bi₂O₃ | Electronics, recording |
| | | media |
| Yttria | Y₂O₃ | Optics |
| Calcium oxide | CaO | Catalysis |
| Strontium oxide | SrO | Ceramic, Catalysis |
| Nickel oxide | NiO | Catalysis, Electronics |
| Ruthenium oxide | RuO | Electronics |
| Indium tin oxide | | Electronics |
| (ITO) | | |
| Aluminates | | |
| Calcium aluminate | CaAl₂O₄ | Ceramics |
| Magnesium | MgAl₂O₄ | Ceramics |
| aluminate | | |
| Barium aluminate | BaAl₂O₄ | Ceramics |
| Strontium | SrAl₂O₄ | Ceramics |
| aluminate | | |
| SILICATES | | |
| Zinc silicate | Zn₂SiO₄ | Optics |
| Yttrium silicate | Y₂SiO₅ | Optics |
| TITANATES | | |
| BARIUM TITANATE | BaTiO₃ | Electronic |
| Strontium | SrTiO₃ | Electronic |
| titanate | | |
| Aluminum titanate | AlTiO | Ceramics |
| Barium-strontium | (Ba₍₁₋ₓ₎Srₓ₎TiO₃ | Electronics |
| titanate | | |
| Mixed or Complex | | |
| Oxides | | |
| Ceria-zirconia | CeO₂:ZrO₂ | Catalysis (automotive) |
| YSZ | ZrO₂:Y₂O₃ | Ceramics, Sensors |
| Alumina-silica | 3Al₂O₃:2SiO₂ | Ceramics |
| (Mullite) | | |
| Strontia-alumina- | SrO—Al₂O₃—SiO₂ | Ceramics |
| silica | | |
| Zinc-silica | ZnO—SiO₂ | Electronic |
| Indium tin oxide | | Electronic, transparent |
| (ITO) | | conductor |
| Metals | | |
| Cobalt | Co | Optics |
| Copper | Cu | Electronics, Optics |
| Silver | Ag | Electronics, Optics |
| Gold | Au | Electronic |
| Platinum | Pt | Catalysis |
| Iridium | Ir | Catalysis |
| METALS ON METAL | | |
| OXIDES | | |
| Platinum on | Pt:Al₂O₃ | Catalysis |
| alumina | | |
| Platinum on tin | Pt:SnO₂ | Electronic |
| oxide | | |
| Platinum on | Pt:TiO₂ | Catalysis |
| titania | | |
| Silver on alumina | Ag:Al₂O₃ | Catalysis |
| Gold on titania | Au:TiO₂ | Electronic |
| Gold on Silica | Au:SiO₂ | Electronic |
| Molybdenum and/or | Mo/Co:Al₂O₃ | Catalysis |
| cobalt on alumina | | |
| COMPLEX | | |
| COMPOSITIONS | | |
| Ferrites | | Electronic |
| Chromates | | Electronic |
| Superconductors | YBaCuO | Electronic |
| METAL DOPED | | |
| MATERIALS | | |
| Europia doped | Y₂O₃:Eu | Optics |
| yttria | | |
| Terbia doped | Y₂SiO₅:Tb | Optics |
| yttrium | | |
| silicate | | |
| | SrTiO₃:Pr | Optics |
| | Zn₂SiO₄:Mn | Optics |
| | (Y_{(1-x-y)}YbₓRe_{y})₂O₃ | Optics |

The product particles that are made using the methods of the present invention may advantageously be made with a specific combination of sizes and properties for use in a desired application. For example, for applications such as pigments, metals for electronics, ceramic green bodies, some solid oxide fuel cells and phosphors, the nanoparticles may preferably be made spheroidal, dense with a larger weight average particle size. For applications such as transparent coatings, some solid oxide fuel cells, inks (for methods of preparing and using inks comprising nanoparticles see, e.g., U.S. Provisional Application Ser. Nos. 60/643,577; 60/643,629; and 60/643,378, all filed on Jan. 14, 2005, the entireties of which are incorporated herein by reference; co-pending non-provisional patent applications bearing Cabot docket numbers 2005A001.2, 2005A002.2, and 2005A003.2, the entireties of which are incorporated herein by reference; and U.S. patent application Ser. Nos. 11/117,701, filed Apr. 29, 2005; 11/199,512, filed Aug. 8, 2005; and 11/199,100, filed Aug. 8, 2005, the entireties of which are incorporated herein by reference), chemical-mechanical polishing, catalysis and taggants/security printing, the nanoparticles may preferably be made to be spheroidal, dense and with a smaller weight average particle size. For applications such as catalysts, the nanoparticles may preferably be made porous with a highly dispersed catalytically active phase decorating the support particles. As another example, the nanoparticles may be made as agglomerates (hard or soft), with the nanoparticles preferably having a larger or a smaller weight average particle size, depending upon the application. For applications such as transparent conductors, rheology additives (e.g., thickeners, flow indicators), chemical-mechanical planarization (CMP), security printing taggants, catalysis, optical applications, cosmetics, and applications involving electrical conductivity the nanoparticles may in some embodiments be made in the form of agglomerates of the nanoparticles. For applications such as structural ceramics, spherical or spheroidal nanoparticles can pack closer together, thus allowing higher solids loading in dispersions and higher density upon sintering. Such nanoparticles also have different Theological properties than aggregates when mixed with materials such as polyester resins, silicones. Aggregates tend to form networks when dispersed in these materials that cause thickening.

The foregoing are just some nonlimiting examples of materials, properties and applications of use for which the product particles may be designed. It should be understood that the product particles formed with the method of the present invention may have a variety of applications in other areas as well, and consequently be made with materials and/or properties, different from or in a different combination than those noted above.

In several aspects of the invention, the nanoparticles are modified in the flame reactor as they are formed or in a separate step after they are formed. The step of modifying the nanoparticles may be useful, for example, to change the properties of the nanoparticles after they have been formed and/or have been grown into a desired weight average particle size. By the term “modify” or “modifying,” it is meant a change to the nanoparticles that does not necessary involve increasing the weight average particle size of the nanoparticles. The modification may be morphological or chemical. By morphological it is meant changes to the structure of the nanoparticles, with some nonlimiting examples including a redistribution of phases within the nanoparticles, creation of new phases within the nanoparticles, crystallization or recrystallization of the nanoparticles, change in porosity and size of pores within the particle, and homogenization of the nanoparticles. A chemical modification to the nanoparticles includes compositional changes to the nanoparticles such as adding an additional component or removing a component from the nanoparticles to change the chemical composition of the nanoparticles, preferably without substantially increasing their weight average particle size, or changing the oxidation state of the component. For example, the nanoparticles may be doped with a doping material to change the luminescent, conductive, electronic, optical, magnetic or other materials properties of the nanoparticles. In another example, a surface modifying material may be added to the surface of the nanoparticles in order to aid the dispersion of the nanoparticles in a suitable medium for use in a final application. In one embodiment, the modification consists of a “polishing” step where additional heat is introduced in the form of flame (e.g., a flame curtain) in order to oxidize any carbon contamination that may exist in the product particles as a result of incomplete combustion in the primary zone. This polishing step is not meant to alter the physical characteristics of the particles (e.g., primary particle size and/or shape), but its purpose is to rid the particles of any undesirable species they may contain. This avoids the need for further post-processing of the particles in a separate processing step after they are made in the flame reactor.

FIG. 8 shows an embodiment of the flame reactor 106 that may be used to implement according to this aspect of the present invention. The flame reactor 106, includes the primary zone 116; the secondary zone 134 and a modifying zone 178. The modifying zone 178 is used to modify the nanoparticles. In some embodiments, unless subjected to a prior quench, the flowing stream in the modifying zone 178 will still be at an elevated temperature because of the residual heat from upstream operations. However, the temperature will often preferably be significantly below those temperatures described above with respect to the secondary zone 134 during the growing step, and a quench may be useful between the secondary zone 134 and the modifying zone 178 to adjust the temperature as desired. For example, the temperature of the nanoparticles when modified will be significantly lower than a melting temperature of any of the materials in the nanoparticles and preferably below the sintering temperature of the nanoparticles, to avoid growth of the nanoparticles through collisions and sintering. In any case, the nanoparticles should be maintained at a temperature at which the desired modification of the nanoparticles occurs.

The descriptions of the various designs of the secondary zone 134 described above are applicable to the modifying zone 178. For example, the modifying zone 178 may include an insulator around the portion of conduit 108 that forms the modifying zone 178. The insulator may be useful to retain heat in the flowing stream while the flowing stream is in modifying zone 178. Additionally, it may be necessary to add heat to modify the nanoparticles, in which case heat will be added to modifying zone 178.

FIG. 8 also shows optional feed 180 of modifying material that may be introduced into the modifying zone 178 for chemical, or compositional modification. The feed 180 of modifying material may be introduced into the modifying zone 178 in a variety of ways, including, all of the ways previously described with respect to the feed 154 of FIG. 6. For example, the modifying feed 180 may be introduced through a burner and into a flame in modifying zone 178.

Feed 180 of modifying material may include multiple phases such as a gas phase and a nongaseous phase. The nongaseous phase may include a liquid, a solid or a combination of a liquid and a solid. The modifying feed 180 includes a modifying material, or a precursor to a modifying material, which modifies the nanoparticles while in the modifying zone 178. The term “modifying material” is meant to include any material that is involved in “modifying” the nanoparticles as the term has been previously defined. The modifying feed 180 may include a gaseous or nongaseous precursor to a modifying material. The precursor to the modifying material may be in a liquid phase of the feed 180, a solid phase of feed 180, in a gaseous phase of feed 180 or a combination of the foregoing.

In addition to nongaseous precursors, feed 180 may also include other components. For example, feed 180 may include gases that are used to carry nongaseous components, such as a precursor, into the modifying zone 178. The modifying feed 180 may also include nongaseous components that are not precursors. As one example, feed 180 may include droplets of water, which are introduced into modifying zone 178 to absorb heat from the flowing stream and control the temperature within modifying zone 178. The foregoing are merely examples of the composition of feed 180 and are not intended to be limiting. In other embodiments, feed 180 may include components that have not been mentioned above, or include any combination of the components that have been mentioned above.

In one specific example of adding a modifying material in feed 180, a material may be introduced in feed 180 that prevents the nanoparticles from growing. The modifying material may be an organic material or an inorganic material that deposits on the surface of the nanoparticulates and prevents them from growing by modifying the surface of the nanoparticles so that when they collide they do not stick together and join. Some nonlimiting examples of ways in which the modifying material may prevent the nanoparticles from sticking together when colliding include, by depositing a material with higher melting point than the core material, thus preventing coalescence and growth of the core particles upon touching each other and by depositing an ionic material that will repel nanoparticles away from each other. It should be noted that the modifying material may increase the weight average particle size of the nanoparticles, because additional material is being added to their surface, but preferably does not significantly increase their size, or if the size is appreciatively increased the weight average particle still remains within a desired range. Moreover, the modifying material may, in addition to being useful to prevent the nanoparticles from growing, be useful in a final application of the nanoparticles. However, in other cases, the modifying material may only be used to prevent the nanoparticles from growing while in flame reactor 106 or agglomerating during or following collection and may be removed before the nanoparticles are used in a final application. The additional material may be removed from the nanoparticles in a variety of ways, such as for example dissolved by a solvent, vaporized, reacted away, or a combination of the foregoing, preferably with minimal effect on the properties of the nanoparticulates.

A compositional modification in the modifying zone 178, may include any modification of the composition of the nanoparticles. One such modification is to coat the particles with a coating material. Such coating may be accomplished in the particle modifying for example, by physical vapor deposition (PVD), chemical vapor deposition (CVD), gas-to-particle conversion, or conversion of a material of the nanoparticles at the particle surface.

It should also be noted that the method of the present invention is not limited to the embodiments described herein where feed 180 is used to introduce a modifying material into the flame reactor. In some instances a modifying material may already be present in the flowing stream when the flowing stream enters the modifying zone 178, such as for example, or by having been introduced into the flame reactor upstream from the modifying zone 178. In those cases, the modifying material may have the same purpose and functions as previously described above with respect to introducing the modifying material in feed 180. In other cases modifying materials may be introduced at other various locations in the flame reactor 106.

The residence times of the nanoparticles within the modifying zone 178 will vary depending on the desired modification of the nanoparticles. Typical residence times of the nanoparticles within the modifying zone 178 may be similar to the residence times within the secondary zone 134, discussed above.

In one specific embodiment of the present invention, the number concentration of nanoparticles in the flowing stream will be controlled so that it is at or below the characteristic number concentration when in the modifying zone 178 to inhibit further particle growth. Additionally, with such a low number concentration of the nanoparticles, modification may be performed at higher temperatures than if the number concentration were above the characteristic number concentration. The concentration of the modifying agent in the modifying zone should be controlled so that it is not high enough to cause separate particle formation from the modifying agent material and not too low so that there is not enough material to cover the surface of the core particles with at least a monolayer.

In other embodiments, the flame reactor may include more than one modifying zone, and the method will include more than one modifying nanoparticles step. Additionally, the modifying nanoparticles steps may be combined in any order with other steps or substeps that have previously been described or that are described below. Each modifying zone can be designed to provide desired mixing between the primary and modifying components to ensure uniform coverage. This arrangement can be used to produce multi-layered coatings on the core particles.

The ability to combine steps and substeps discussed above provides advantages in processing nanoparticles with complex materials (i.e., materials with more than two elements). Some examples of complex materials include mixed metal oxides such as phosphors, perovskites and glasses. One problem with processing nanoparticles that include complex materials is that oftentimes the component materials in the complex materials have very different properties such as vaporization temperatures (i.e., boiling points) that make formation of the nanoparticles in a single processing step difficult. For example, a first component of the complex material may have a very high vaporization temperature, while a second component a very low vaporization temperature. If processed in a single step, both components will be in a single gas phase while in a primary zone. As the temperature of the gas phase drops, the first component will nucleate and form nanoparticles, then as the temperature falls further, the second component will deposit on the first component and/or nucleate and form separate nanoparticles. Thus, the resulting nucleated nanoparticles will be nanoparticles with two phases (i.e., core/shell) and/or two separate nanoparticles of distinct compositions. Such materials may be of particular interest for catalyst applications.

In several embodiments of the present invention, a combination of substeps that include combinations of the growing step, quenching step and modification step may be used in various modes to process nanoparticles that include complex materials. One example includes introducing a first component, having a high-vaporization temperature, and a second component having a low-vaporization temperature into a primary zone of a flame reactor. As the nanoparticles begin to nucleate and form, they may be subjected to a quenching nanoparticles step that reduces the temperature of the nanoparticles to a temperature below the vaporization temperature of the second component in the form it exists in the vapor phase, causing the second component to come out of the vapor phase for inclusion in the nanoparticles, promoting inclusion of both the first component and the second component in the nanoparticles. Additionally, the quenching nanoparticles may be followed by a modifying nanoparticles where the nanoparticles are maintained at a temperature that will homogenize them to evenly distribute the first and second components throughout the nanoparticles.

4. Product Particle Quenching

In several aspects of the invention, the product particles (preferably nanoparticles) formed according to the present invention are quenched with a quenching medium in the primary zone of the reactor to reduce their temperature. The quenching step involves reducing the temperature of the nanoparticles by mixing a quench stream into the flowing stream in the flame reactor. The quench stream used to lower the temperature of the nanoparticles is at a lower temperature than the flowing stream, and when mixed with the flowing stream it reduces the temperature of the flowing stream, and consequently also the nanoparticles in the flowing stream. The quenching step may reduce the temperature of the nanoparticles by any desired amount. For example, the temperature of the flowing stream may be reduced at a rate of from about 500° C./s to about 40,000° C./s. In some applications, the temperature of the flowing stream may be reduced at a rate of about 30,000° C./s, or about 20,000° C./s, or about 10,000° C./s, or about 5,000° C./s or about 1,000° C./s. Typically, however, the temperature of the flowing stream should not be cooled at a rate such that contaminant materials would condense out of the gas phase in the flowing stream. Furthermore, the quenching rate should not be so high so as to prevent complete conversion of the precursor(s) to product particles.

FIG. 7 shows one embodiment of the flame reactor 106 that employs a quenching step. In addition to a primary zone 116, flame reactor 106 includes a quench zone 162. The quench zone 162 is immediately downstream of the primary zone 116. A feed 164 of quench medium is introduced into quench zone 162 for mixing with the flowing stream. Mixing the cooler quench medium into the flowing stream reduces the temperature of the flowing stream and any nanoparticles in the flowing stream. In one embodiment, the quenching is done in the primary zone. This is accomplished by introducing the quenching medium through the burner and around the precursor jet by properly designing the spray nozzle. This provides a cooling “envelope” that surrounds the main jet flame. Alternatively, the quenching medium can be introduced into the center of the burner and may be surrounded by the flame. This allows quenching of the flame from its core. Finally, a combination of the above two approaches can be used to cool the flame internally and externally.

The flame reactor 106 shown in FIG. 7 is only one embodiment of a flame reactor useful to implement the embodiment of a reactor employing a quench step. The flame reactor 106 shown in FIG. 7 shows the quench zone as within a same conduit configuration as the primary zone 116. However, in other embodiments, the quench zone may be in a conduit portion having a different shape, diameter or configuration than the primary zone 116. One example of a quench system that may be used as a quench zone to implement the method of the present invention is disclosed in U.S. Pat. No. 6,338,809, the entire contents of which are hereby incorporated by reference as if set forth herein in full.

The quench medium preferably comprises a quench gas. The quench gas used in the quenching step may be any suitable gas for quenching the nanoparticles. The quench gas may be nonreactive after introduction in the flame reactor and introduced solely for the purpose of reducing the temperature of the flowing stream. This might be the case for example, when it is desired to stop the growth of the nanoparticles through further collisions. The quenching step helps to stop further growth by diluting the flowing stream, thereby decreasing the frequency of particle collisions, and reducing the temperature, thereby reducing the likelihood that colliding particles will fuse together to form a new primary particle. When it is desired to stop further particle growth, the cooled stream exiting the quenching step should preferably be below a sintering temperature of the nanoparticulates. The cooled nanoparticles may then be collected—i.e., separated from the gas phase of the flowing stream. The quenching step may also be useful in retaining a particular property of the nanoparticles as they have formed and nucleated in the flowing stream. For example, if the nanoparticles have nucleated and formed with a particular phase that is desirable for use in a final application, the quenching step may help to retain the desirable phase that would otherwise recrystallize or transform to a different crystalline phase if not quenched. In other words, the quenching step may be useful to stop recrystallization of the nanoparticles if it is desirable to retain a particular crystal structure that the nanoparticles have nucleated and formed with. Alternatively, the quench gas may be nonreactive, but is not intended to stop nanoparticulate growth, but instead to only reduce the temperature to accommodate some further processing to occur at a lower temperature. As another alternative, the quench gas may be reactive in that it includes one or more components that is or becomes reactive in the flame reactor, such as reactive with material of the nanoparticles or with some component in the gas phase of the flowing stream in the flame reactor. As one examples the quench gas may contain a precursor for additional material to be added to the nanoparticles. The precursor may undergo reaction in the quench zone prior to contributing a material to the nanoparticulate, or may not undergo any reactions. In one specific example, the quench gas may contain oxygen, which reacts with a metal in the nanoparticles to promote production of a metal oxide in the nanoparticles or it may react with carbon contained in the nanoparticles to convert it to CO₂. The quenching may also help in production of metastable phases by kinetically controlling and producing a phase that is not preferred thermodynamically.

In addition to a gas phase, a quench medium introduced into the flame reactor may also include a nongaseous phase—e.g., a disperse particulate and/or disperse droplet phase, or liquid stream. The nongaseous phase may have any one of a variety of functions. For example, a nongaseous phase may contain precursor(s) for material(s) to be added to the nanoparticles. As another example, the quench gas may include a nongaseous phase that assists in lowering the temperature of the nanoparticulates, such as water droplets included to help consume heat and lower the temperature as the water vaporizes after introduction into the flame reactor. Other nongaseous phases may be used to assist lowering the temperature by consumption of heat through vaporization, however water is often preferred because of its low cost and high latent heat of vaporization.

In one aspect, the quenching step is followed by the growing step, which are each the same as discussed previously.

In another aspect, the quenching step is also a collection step. The feed 164 of quench medium is a liquid stream that simultaneously reduced the temperature and collects nanoparticles.

FIG. 7 also shows another embodiment of the flame reactor 106 that includes the quench zone 162 followed by the secondary zone 134. As shown in FIG. 7, the feed 120 including the nongaseous precursor, as discussed previously, is introduced into flame reactor 106 through burner 112 and into flame 114 in primary zone 116. Within primary zone 116 nanoparticles nucleate and form in the flowing stream. The flowing stream is then quenched in the quench zone 162 and then the nanoparticles are further grown in the secondary zone 134.

As one example referring to FIG. 7, the nanoparticles that form in the flowing stream may have a crystal structure that is useful for a final application and it is desirable to retain the crystal structure, which is otherwise lost if kept at the temperature of the flowing stream as it exits primary zone 116. The feed 164 of quench gas introduced into quench zone 162 cools the nanoparticles to a temperature that retains the desirable crystal structure. The secondary zone 134 downstream of the quench zone may then be used to further grow the nanoparticles while retaining the desired crystal structure.

As another example with reference to FIG. 7, the nanoparticles that nucleate and form in the flowing stream in primary zone 116 may be at a temperature at which they grow more quickly than desired. Quenching in the quench zone 162 temporarily stops or slows down the growth of the nanoparticles. After the quench zone 162, the nanoparticles flow into the secondary zone 134, where they may be controllably grown into a desired weight average particle size. Processing in the secondary zone may include, for example, addition of precursor to add additional material to the nanoparticles, or addition of heat to raise the temperature of the flowing stream to controllably recommence or accelerate the rate of particle growth through collisions.

In other aspects of the invention, there are multiple quench steps. For example, after the component from the nongaseous precursor is transferred through the gas phase, there may be a first quenching step, followed by a step of growing the nanoparticles, and a second quenching after the growing step. Thus, the method of the present invention may include one or two quenching steps or more than two quenching steps. In some embodiments, a quenching step may follow and/or precede other processing steps or substeps that have been previously described, or other steps not described herein the inclusion of which are not incompatible with other processing. The quenching step can occur as close to the flame as in the primary zone and as far from the flame as just before particle collection. In one embodiment, the quenching can take place at the flame itself by properly designing the burner to allow introduction of quench fluid around the main spray nozzle. This is preferred in cases where very high surface area amorphous materials are desirable. Additionally, in those embodiments that include more than one quenching step, the quench fluid used in each of the steps may be the same or different.

5. Product Particle Collection

In a preferred aspect of the invention, the product particles formed according to the processes of the invention are collected in a collecting nanoparticles step. The step of collecting the nanoparticles may be performed using any suitable methods or devices for separating solid particulate materials from gases.

In one embodiment, the nanoparticles are collected dry. In this embodiment, the collecting nanoparticles step may be performed for example, by using filters, such as a bag house, electrostatic precipitators or cyclones (especially for product particles larger than 500 nm). Bag house filters are a preferred device for performing the collecting nanoparticles step when the collecting nanoparticles step is performed to collect the nanoparticles in a dry state.

In other embodiments, the nanoparticles may be collected using a collection liquid. Any suitable device or method for separating solid particulates from gases using a collection liquid may be used with this embodiment of the present invention. Some nonlimiting examples of devices that may be used in this embodiment include venturi liquid scrubbers, which use a spray of collection liquid to separate nanoparticles from a gas. A wet wall may also be used to separate the nanoparticles from gases. The nanoparticulates may be passed through a wall of liquid, so that the nanoparticulates are captured by the liquid while the gases flow through the wet wall. In another embodiment, a wet electrostatic precipitator which works similar to the electrostatic precipitator previously discussed but includes a wet wall where the nanoparticles are collected is used to perform the collecting nanoparticles step. In yet another example, the nanoparticles may be collected in a liquid bath. The flowing stream containing the nanoparticles may be directed into or bubbled through a bath of collection liquid, where the nanoparticulate will be collected and the gases will flow through the liquid. These are intended only to be some nonlimiting examples of devices and methods by which the nanoparticles may be collected using a collecting liquid.

The use of a collecting liquid for performing the collecting nanoparticles step provides a variety of advantages. In one specific embodiment of the present invention, the collecting liquid used in collecting the nanoparticles step contains a surface modifying material. By the term “surface modifying material”, it is meant a material that interacts with the surface of the nanoparticles to change the properties of the surface of the nanoparticles. For example, the surface modifying material may deposit material onto the surface of the nanoparticles, bond surface groups to the nanoparticles or associate materials with the surface of the nanoparticles. In other cases, the surface modifying material may remove material from the nanoparticles, such as by removing surface groups or by etching material from the surface of the nanoparticulates. Additionally, the surface modifying material can be such that it creates a lyophobic, lyophilic, hydrophobic, or hydrophilic surface, thus, controlling compatibility and redispersion of the nanoparticle with a wide variety of solvents and substrates.

In one embodiment, the surface modifying material will interact with the nanoparticles to prevent the nanoparticles from sticking together, in other words, the surface modifying material allows the nanoparticles to remain in a disperse state while in the collection liquid and to easily disperse the nanoparticles for use in a final application. In some embodiments, the surface modifying material may deposit around the entire outside surface of the nanoparticles to prevent the nanoparticles from sticking together. In another embodiment, the surface modifying material may simply associate the surface of the nanoparticles in a way that keeps them dispersed. Some examples of surface modifying materials which may be included in the collection liquid include surfactants, such as ionic surfactants, non-ionic surfactants and zwitterionic surfactants and dispersants.

In some cases, the surface modifying material may not deposit onto the surface of the nanoparticles or associate with the surface of the nanoparticles but rather may remove material from the surface of the nanoparticles. For example, if there are materials that were present within the flame reactor that are deposited onto the surface of the nanoparticles, but it is desirable to remove those materials prior to use of the nanoparticles in a final application, the collection liquid may include a surface modifying material that removes the unwanted material from the surface of the nanoparticles. In other cases, it may be desirable for a final application to increase the specific surface area of the nanoparticles. In this embodiment, the collection liquid may include a surface modifying material that will slightly etch or remove material from the surface of the nanoparticles in order to increase the specific surface area of the nanoparticles. In yet another case, the collection liquid may include a material that will leach or remove in other ways, in whole or in part, the support particle material to produce highly porous component particles.

IV. Nozzle Assembly

In one embodiment, the invention provides a nozzle assembly comprising (a) a substantially longitudinally extending atomizing feed nozzle comprising an atomizing medium conduit and one or more substantially longitudinally extending precursor medium feed conduits; and (b) a substantially longitudinally extending sheath medium nozzle

As used herein, the term “nozzle assembly” refers to an assembly comprising an atomizing feed nozzle and a sheath medium nozzle. The nozzle assembly may optionally contain a fuel/oxidant conduit which acts to provide a pilot flame for the flame spray processes described herein. The nozzle assembly may also optionally contain a sheath medium plenum comprising a sheath medium plenum inlet through which the sheath medium is introduced into the nozzle assembly and subsequently into the internal reactor volume. The nozzle assembly has a proximal end and a distal end. The proximal end of the nozzle assembly is the end that is closest to the various feeds (e.g., fuel/oxidant feed) that are fed into the nozzle assembly. The distal end of the nozzle assembly is the end that is downstream from various feeds that are fed into the nozzle assembly.

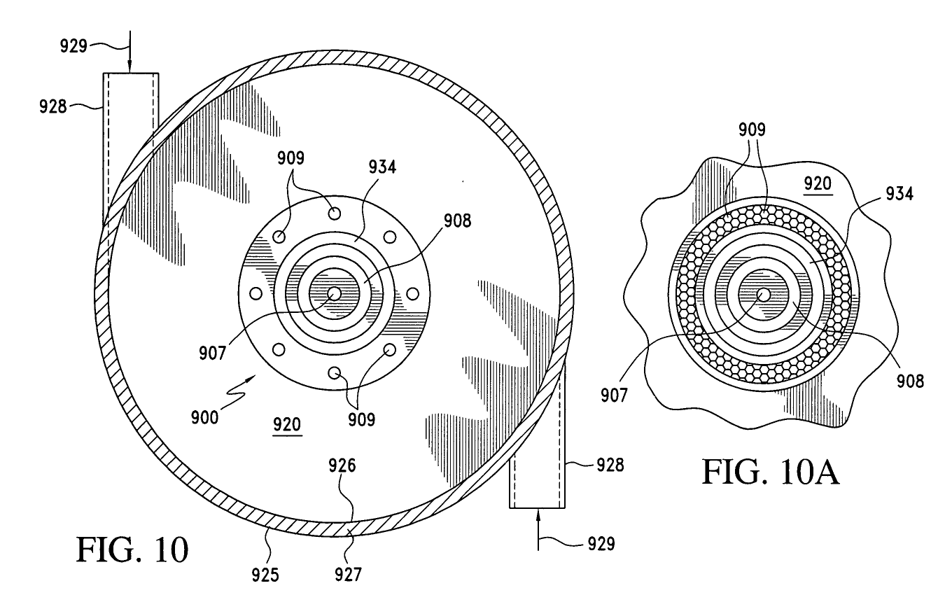

As used herein, the term “fuel/oxidant conduit” refers to an annular space within the nozzle assembly through which fuel and/or oxidant flows from a fuel/oxidant feed source into the internal reactor volume. The fuel/oxidant conduit may have any configuration. Two non-limiting configurations are shown in FIGS. 10 and 10A. FIG. 10 shows a nozzle assembly comprising a plurality of cylindrical fuel/oxidant conduits in a cylindrical arrangement about the atomizing feed nozzle. FIG. 10A shows a nozzle assembly comprising a plurality of fuel/oxidant conduits in a honeycomb (i.e., hexagonally shaped fuel/oxidant conduits) configuration. The skilled artisan will recognize that the honeycomb structure can be comprised of conduits of various different shapes, in addition to the shape illustrated in FIG. 10A. For example, the fuel/oxidant conduits may be substantially cylindrical, square or even triangular in shape.

The nozzle assembly may also optionally contain one or more auxiliary conduits. As used herein, the term “auxiliary conduit” refers to an annular space within the nozzle assembly through which an auxiliary material flows from an auxiliary material feed source into the internal reactor volume. The auxiliary materials that may be fed into the auxiliary conduit include, but are not limited to, air, oxygen, precursor medium, gaseous fuels, liquid fuels, or quench fluids. Spray nozzle atomizers that comprise a two-fluid, a three-fluid or a four-fluid nozzle are examples of nozzle assemblies that comprise one or more auxiliary conduits.

As used herein, the term “atomizing feed nozzle” refers to a nozzle that comprises only the atomizing medium conduit and the one or more precursor medium feed conduits. The atomizing medium comprises a gas. In one embodiment, the atomizing medium comprises a gas that comprises one or more of air, nitrogen, oxygen or water vapor. In another embodiment, the atomizing medium comprises a gas that comprises one or more of argon, H₂, CO₂, CO, supercritical CO₂, water vapor and gaseous fuels such as alkanes and other light hydrocarbons.

As used herein, the term “atomizing medium conduit” refers to an annular space within the atomizing feed nozzle through which an atomizing medium flows from an atomizing medium feed into the internal reactor volume.

As used herein, the term “precursor medium feed conduit” refers to an annular space within the atomizing feed nozzle through which a precursor medium flows from the precursor medium feed into the internal reactor volume.

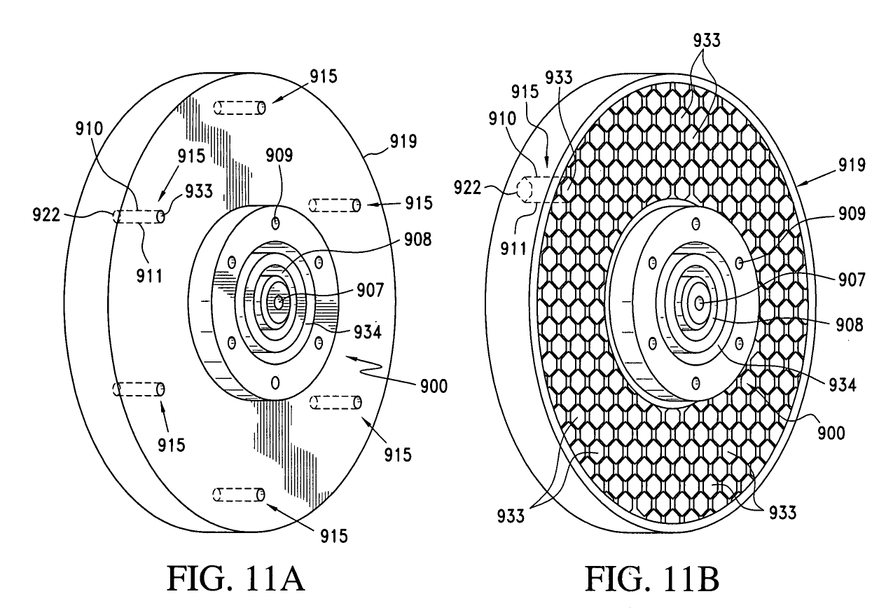

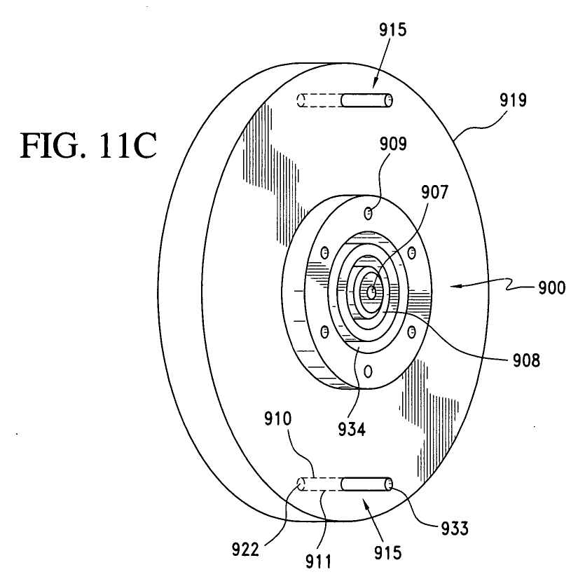

As used herein, the term “sheath medium nozzle” refers to a nozzle through which the sheath medium flows from the sheath medium plenum inlet, into the sheath medium plenum and ultimately into the inner reactor volume. In one embodiment, the sheath medium preferably comprises a gas. In one embodiment, the sheath medium comprises a gas that comprises one or more of air or nitrogen. In another embodiment, the sheath medium comprises a gas that comprises one or more of oxygen, off gas recycle, and water vapor. In another embodiment, the sheath medium further comprises atomized water. If the sheath medium comprises atomized water, the sheath medium optionally comprises the atomized water in an amount ranging from about 10 to about 100 percent by volume, e.g., from about 50 to about 100 percent or from about 90 to about 100 percent, based on the total volume sheath medium. Without being bound by theory, the function of the sheath medium is to, inter alia, (a) cooling the flame; (b) facilitate the flow through the flame spray system of product particles produced when the precursor medium is flame sprayed according to the processes of the present invention; (c) maintain cool any metal surfaces located around the flame; (d) to prevent the formation of areas of turbulence that may form within the internal reactor volume surrounding the burner and/or the flame; and (e) for the introduction of additional materials, e.g., oxidant or additional precursor medium, to the flame and/or the internal reactor volume. In some embodiments, the sheath medium is introduced into the internal reactor volume such that the sheath medium substantially surrounds the flame. In other embodiments, such as those described in greater detail in FIG. 11C, the sheath medium does not substantially surround the flame.

In another embodiment, the invention provides a nozzle assembly comprising (a) a substantially longitudinally extending atomizing feed nozzle comprising an atomizing medium conduit and one or more precursor medium feed conduits, (i) wherein the atomizing medium conduit has a first end for receiving an atomizing medium from an atomizing medium source and a second end through which the atomizing medium exits the atomizing feed nozzle, and (ii) wherein the precursor medium feed conduit has a first end for receiving a precursor medium from a precursor medium source and a second end through which the precursor medium exits the atomizing feed nozzle; and (b) at least one substantially longitudinally extending sheath medium nozzle comprising a first end for receiving a sheath medium from a sheath medium source and a second end through which the sheath medium exits the sheath medium nozzle.

In one embodiment, the atomizing medium conduit and the precursor medium feed conduit are substantially coaxial with respect to one another. In another embodiment, the nozzle assembly is located within a flame spray system. In yet another embodiment, the nozzle assembly is located within an enclosed flame spray system.

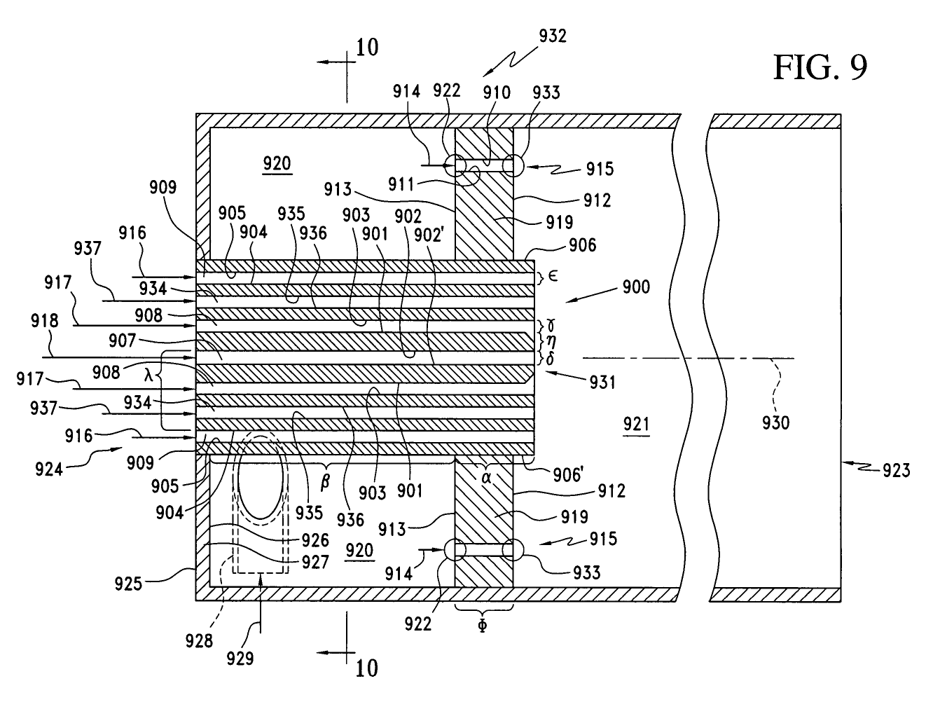

FIG. 9 presents one non-limiting diagram of a nozzle assembly 932 according to one aspect of the invention. The nozzle assembly 932 comprises a substantially longitudinally extending, substantially cylindrical, atomizing feed nozzle 900 with outer walls 904. The nozzle assembly has a proximal end 924 and a distal end 923. The nozzle assembly optionally further comprises one or more fuel/oxidant conduits 909 defined by a fuel/oxidant conduit wall 905. In one embodiment, the nozzle assembly comprises a plurality of fuel/oxidant conduits 909 arranged in a cylindrical fashion and circumscribing atomizing medium conduit 908 and precursor medium feed conduit 907, as shown in FIG. 10. In another embodiment, the nozzle assembly comprises one or more auxiliary conduits 934 with outer wall 935. The auxiliary conduit 934 is fed from auxiliary material feed 937. The shape of the nozzle assembly is preferably substantially cylindrical, although the shape of the nozzle assembly may be of any suitable geometric shape (e.g., square and oval).

With continuing reference to FIG. 9, the fuel/oxidant conduit 909 is fed from fuel/oxidant feed 916 and the fuel/oxidant flows from the proximal end 924 of the nozzle assembly to the distal end 923 of the nozzle assembly. The fuel/oxidant is ignited, e.g., with an additional pilot flame, as it exits the fuel/oxidant conduit 909 at the distal end of the nozzle assembly, thereby forming a flame that directly heats the internal reactor volume 921. As discussed in greater detail above, fuel and oxidant are fed into a flame via a conduit, such as conduit 909 in a ratio that is sometimes determined by the type of materials that are made using the flame spray process described herein. Further, the specific type of fuel that is fed into a flame via conduit 909 may be gaseous or nongaseous. Finally, the oxidant used in the method of the present invention to combust with the fuel to form the flame may be a gaseous oxidant or a nongaseous oxidant.

The atomizing feed nozzle of the nozzle assembly comprises an atomizing medium conduit 908 defined by an atomizing medium conduit inner wall 901 and an atomizing medium conduit outer wall 903. The atomizing medium conduit 908 is fed by atomizing medium feed 917. The atomizing feed nozzle also comprises a precursor medium feed conduit 907 defined by precursor medium feed conduit wall 902. The precursor medium feed conduit is fed from precursor medium feed 918.

The atomizing medium flows through atomizing medium conduit 908, under pressure, from the proximal end 924 of the nozzle assembly to the distal end 923 of the nozzle assembly. Likewise, the precursor medium flows through the precursor medium feed conduit 907, under pressure, from the proximal end 924 of the nozzle assembly to the distal end 923 of the nozzle assembly. As the atomizing medium and the precursor medium exit the atomizing medium conduit 908 and the precursor medium feed conduit 907, respectively, at the distal end of the nozzle assembly 923, the atomizing medium causes the precursor medium to atomize to form droplets as the precursor medium is introduced into the internal reactor volume 921. The atomized precursor medium is subsequently ignited to form a flame. The source of ignition of the atomized precursor medium is preferably the flame that is formed by the ignition of the fuel/oxidant.

As shown in FIG. 9, the precursor medium feed conduit 907 has a diameter δ, the atomizing medium conduit 908 has a diameter γ, and the fuel/oxidant conduit 909 has a diameter ε, all of which are preferably measured in millimeters. The precursor medium conduit 907 and the atomizing medium conduit 908 are separated by a distance η. The fuel/oxidant conduit 909 and the precursor medium feed conduit 907 are separated by a distance λ The value of η must be such that the precursor medium conduit 907 is sufficiently close to atomizing medium conduit 908 so that the precursor medium that flows out of the precursor medium conduit is atomized by the atomizing medium that flows out of the atomizing medium conduit. The value of λ must be such that the flame formed from the ignition of the fuel/oxidant is sufficiently close to the precursor medium conduit so that the precursor medium is ignited by the fuel/oxidant flame during the flame spray processes of the present invention.

The value of δ controls (i) the size of the precursor medium droplets that flow out of the precursor medium feed conduit; and (ii) the amount of precursor medium that may be flame sprayed (i.e., throughput) according to the processes of the invention. The value of γ controls the amount of atomizing medium that may flow out of the atomizing medium conduit. The value of ε controls the volume and velocity the of fuel/oxidant that flows out of the fuel/oxidant conduit.

In one embodiment, the atomizing feed nozzle 900 is circumscribed by, and is in direct contact with, a sheath medium nozzle support structure 919 defined by a sheath medium nozzle support structure inner wall 913 and a sheath medium nozzle support structure outer wall 912. The sheath medium nozzle support structure comprises a plurality of substantially longitudinally extending sheath medium nozzles 915 defined by sheath medium nozzle wall 910. As shown, the sheath medium nozzle support structure optionally is formed of a “plate” with holes in it defining the sheath medium nozzles 915. The shape of the sheath medium nozzle support structure is preferably substantially cylindrical, although the shape of the sheath medium nozzle support structure may be of any suitable geometric shape (e.g., square and oval). Likewise, the shape of the sheath medium nozzles is preferably substantially cylindrical, although the shape of the sheath medium nozzles may be of any suitable geometric shape (e.g., square and oval).

Once again referencing FIG. 9, the sheath medium nozzle 915 is in fluid communication with sheath medium plenum 920, via sheath medium inlet 922. The sheath medium nozzle also comprises a sheath medium outlet 933 out of which the sheath medium flows into the internal reactor volume. Sheath medium plenum 920 is housed within a sheath medium plenum housing 927 comprising sheath medium plenum housing inner wall 926 and sheath medium plenum housing outer wall 925. Sheath medium feed 929 feeds into the plenum 920 via inlet 928, where the inlet 928 is located on housing 927.

As shown in FIG. 9, the atomizing feed nozzle may protrude through the sheath medium nozzle support structure 919 a distance α, preferably measured in millimeters, from the sheath medium nozzle support structure inner wall 913 to the tip of the atomizing feed nozzle 931. In addition, the atomizing feed nozzle 900 extends a distance β, preferably measured in millimeters, from the inner sheath medium plenum housing wall 926 to the sheath medium nozzle support structure inner wall 913, as shown. Finally, the sheath medium nozzle support structure is of longitudinal thickness Φ, preferably measured in millimeters from the sheath medium nozzle support structure inner wall 913 to the sheath medium nozzle support structure outer wall 912. In some embodiments, the distance α is zero. When the distance α is zero, the tip of the atomizing feed nozzle 931 is flush with the sheath medium nozzle support structure inner wall 913.

FIG. 10 provides a front-end cross sectional view of the nozzle assembly in FIG. 9. As shown in FIG. 10, the sheath medium plenum inlet 928 is preferably located on the sheath medium plenum housing 927 such that the sheath medium is introduced into the sheath medium plenum 920 tangentially, along the inner plenum housing wall 926. Making reference to FIG. 9, after its introduction, the sheath medium subsequently flows from the plenum 920, through sheath medium outlet 922 and into the internal reactor volume 921. One benefit of introducing the sheath medium tangentially along the inner plenum housing wall is that it allows uniform and even distribution of the sheath medium through the sheath medium nozzle support structure and around the flame. While the skilled artisan will recognize the benefits of introducing the sheath medium into the sheath medium plenum tangentially along the inner plenum housing wall, the sheath medium may be introduced into the plenum in a variety of directions. For example, the sheath medium may be introduced in a direction that is substantially parallel to the longitudinal axis denoted by phantom axis line 930, in FIG. 9. Referencing FIG. 9 once again, it should be noted that the volume of the sheath medium plenum should be large enough such that the sheath medium flows out substantially evenly from the two sheath medium nozzles 915 and not preferentially from the “upper” sheath medium nozzle shown.

As discussed above in reference to FIG. 9, the sheath medium nozzle support structure 919 comprises one or more substantially longitudinally extending sheath medium nozzles 915. FIGS. 11A, 11B and 11C show other embodiments of the sheath medium nozzle support structure. FIG. 11A shows a sheath medium nozzle support structure 919 that comprises a plurality of substantially longitudinally extending sheath medium nozzles 915 that are arranged in a cylindrical fashion about the nozzle assembly 900. FIG. 11B shows a sheath medium nozzle support structure 919 that is in the form of a honeycomb (i.e., hexagonally shaped sheath medium nozzles). The skilled artisan will recognize that a sheath medium nozzle support structure in the form of a honeycomb will comprise hundreds or even thousands of substantially longitudinally extending sheath medium nozzles 915, depending on the size of each nozzle. Even in this honeycomb arrangement, the sheath medium nozzles can be considered to be arranged in a cylindrical form, substantially coaxial with the atomizing feed nozzle 900. The skilled artisan will also recognize that the honeycomb structure can be comprised of substantially longitudinally extending sheath medium nozzles of various different shapes, in addition to the shape illustrated in FIG. 11B. For example, the substantially longitudinally extending sheath medium nozzles may be substantially cylindrical, square or even triangular in shape. Finally, FIG. 11C shows a sheath medium nozzle support structure 919 that comprises a plurality of sheath medium nozzles 915 that extend substantially parallel to the atomizing feed nozzle 900.

In some embodiments, the sheath medium nozzle support structure 919 may be made of a porous plate (e.g., sintered glass and wire mesh).

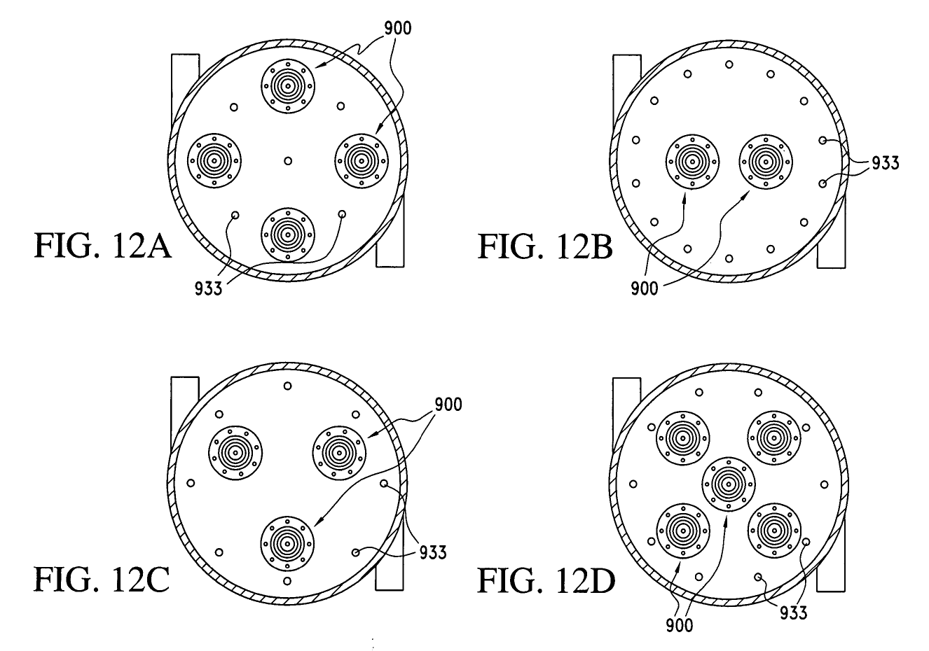

FIG. 9, above, illustrates a nozzle assembly that comprises one substantially longitudinally extending atomizing feed nozzle 900. Other nozzle assemblies are contemplated, however, that have a plurality of substantially longitudinally extending atomizing feed nozzles 900. The plurality of substantially longitudinally extending feed nozzles may be arranged in a variety of arrays. Four such arrays are illustrated in FIGS. 12A, 12B, 12C, and 12D. FIG. 12A shows an array of four atomizing feed nozzles 900 and five sheath medium nozzles 915 arranged on the sheath medium nozzle support structure 919 in a cross shape. FIG. 12 B shows an array of a plurality of sheath medium nozzles 915 circumscribing two atomizing feed nozzles 900. FIG. 12C shows an array of a plurality of sheath medium nozzles 915 circumscribing three atomizing feed nozzles 900, where the atomizing feed nozzles are arranged in a triangular shape. FIG. 12D shows an array of a plurality of sheath medium nozzles 915 circumscribing five atomizing feed nozzles 900, where the atomizing feed nozzles are arranged in a cross shape.

FIG. 9, above, also illustrates a nozzle assembly that comprises a substantially longitudinally extending atomizing feed nozzle 900 that comprises an atomizing medium conduit and a precursor medium feed conduit that are substantially coaxial with respect to one another. Further, FIG. 9 illustrates an atomizing feed nozzle where the precursor medium feed conduit is located within the atomizing medium conduit. Other atomizing feed nozzles are contemplated, however, where the atomizing medium conduit is located within the precursor medium feed conduit. Thus, it is contemplated that the atomizing medium conduit may be situated within the precursor medium conduit in any of the embodiments discussed above.

### EXAMPLES

The present invention is further described with reference to the following non-limiting examples.

### Example 1

### Cerium Oxide

Cerium 2-ethylhexanoate mixed with toluene is used as the precursor solution for the synthesis of ceria powder. The cerium metal weight percent in the precursor solution varied from 6 to 7.7. The precursor flow rate and dispersion oxygen flow rate were 15 ml/min and 25 SLPM, respectively. Different furnaces were used to change the residence time and temperature profile in the reactor. The surface area of particles varied from 48 m2/gm to 179 m2/gm. Scanning electron microscopy (SEM) and tunneling electron microscopy (TEM) analysis of the powder shows that primary particle size varied from 15 to 25 nm and the primary aggregate size varied from 50 to 100 nm. The synthesized ceria powders can be used for catalyst support, chemical mechanical polishing, and as an electrocatalyst.

### Example 2

### Silicon Titanium Oxide Powder

Titanium Diisopropoxide and hexamethyldisiloxane mixed with ethanol is used as the precursor solution for the synthesis of silicon titanium oxide powder. The precursor flow rate varied from 15 to 40 ml/min and dispersing oxygen flow rate varied from 25 to 50 SLPM. The surface area of particles varied from 34 to 120 m²/gm. The synthesized silicon titanium oxide powders can be used as catalyst and fillers.

Any feature described or claimed with respect to any disclosed implementation may be combined in any combination with any one or more other feature(s) described or claimed with respect to any other disclosed implementation or implementations, to the extent that the features are not necessarily technically incompatible, and all such combinations are within the scope of the present invention. Furthermore, the claims appended below set forth some non-limiting combinations of features within the scope of the invention, but also contemplated as being within the scope of the invention are all possible combinations of the subject matter of any two or more of the claims, in any possible combination, provided that the combination is not necessarily technically incompatible.

What is claimed is:

1. A process for decreasing flame temperature of a flame in a flame spray reaction system, the process comprising the steps of:
(a) providing a precursor medium comprising a precursor to a component;
(b) flame spraying the precursor medium under conditions effective to form a population of product particles; and
(c) decreasing the flame temperature by contacting said flame with a cooling medium.

2. The process of claim 1, wherein the product particles comprise particles selected from the group consisting of catalyst particles, phosphor particles, and magnetic particles.

3. The process of claim 1, further comprising the steps of:
(d) collecting the product particles; and
(e) dispersing the product particles in a liquid medium.

4. The process of claim 3, further comprising the step of:
(f) applying the liquid medium onto a surface.

5. The process of claim 4, further comprising the steps of:
(g) heating the surface to a maximum temperature below 500° C. to form at least a portion of an electronic component.

6. The process of claim 4, wherein the applying comprises ink jet printing or screen printing.

7. The process of claim 4, further comprising the step of:
(g) heating the surface to form at least a portion of a feature selected from the group consisting of a conductor, resistor, phosphor, dielectric, and a transparent conducting oxide.

8. The process of claim 7, wherein the feature comprises a ruthenate resistor or a titanate dielectric.

9. The process of claim 7, wherein the surface is heated to a maximum temperature below 500° C.

10. The process of claim 1, further comprising the steps of:
(d) collecting the product particles; and
(e) forming an electrode from the product particles.

11. The process of claim 10, wherein the electrode comprises a fuel cell electrode.

12. The process of claim 11, wherein the product particles exhibit corrosion resistance.

13. The process of claim 1, wherein the product particles maintain a surface area of at least 30 m²/g after exposure to air at 900° C. for 4 hours.

14. The process of claim 1, further comprising the steps of:
(d) collecting the product particles; and
(e) forming an optical feature from the product particles.

15. The process of claim 1, wherein the precursor medium further comprises a liquid vehicle.

16. The process of claim 1, wherein the cooling medium comprises a gas.

17. The process of claim 16, wherein the gas comprises one or more of air, nitrogen, argon, oxygen, hydrogen, water vapor or a combination thereof.

18. The process of claim 16, wherein the cooling medium further comprises atomized water.

19. The process of claim 1, wherein the flame is located within an enclosed flame spray reaction system.

20. The process of claim 1, wherein the temperature of the flame is decreased at a rate of at least of 1,000° C. per second.

21. The process of claim 1, wherein the temperature of the flame is decreased at a rate of at least of 5,000° C. per second.

22. The process of claim 1, wherein the temperature of the flame is decreased at a rate of at least of 10,000° C. per second.

23. The process of claim 1, wherein the cooling medium contacts the flame at about a 180° angle.

24. The process of claim 1, wherein the cooling medium contacts the flame at about a 90° angle.

25. The process of claim 1, wherein the cooling medium contacts the flame at about a 45° angle.

26. The process of claim 1, wherein the cooling medium contacts the flame at about a 25° angle.

27. A process for decreasing flame temperature in a flame spray reaction system, the process comprising the step of decreasing the flame temperature at a rate of about 900° C. per second to about 10,000° C. per second by contacting said flame with a cooling medium.

28. The process of claim 27, wherein the temperature of the flame is decreased at a rate of about 1,000° C. per second to about 5,000° C. per second.

29. The process of claim 27, wherein the temperature of the flame is decreased at a rate of 2500° C. per second to about 7500° C. per second.

30. The process of claim 27, wherein the temperature of the flame is decreased at a rate of about 5000° C. to about 10,000° C. per second.

31. The process of claim 27, wherein the temperature of the flame is decreased at a rate of about 1,000° C. per second.

32. The process of claim 27, wherein the temperature of the flame is decreased at a rate of 5000° C. per second.

33. The process of claim 27, wherein the temperature of the flame is decreased at a rate of about 10,000° C. per second.

34. A process for decreasing flame temperature in a flame spray reaction system, the process comprising the step of decreasing the flame temperature by directly contacting said flame with a cooling medium at an angle of about 25 degrees to about 180 degrees.

35. The process of claim 34, wherein the angle is about 25 degrees to about 90 degrees.

36. The process of claim 34, wherein the angle is about 75 degrees to about 120 degrees.

37. The process of claim 34, wherein the angle is about 110 degrees to about 150 degrees.

38. The process of claim 34, wherein the angle is about 145 degrees to about 180 degrees.

39. The process of claim 34, wherein the angle is about 25 degrees.

40. The process of claim 34, wherein the angle is about 45 degrees.

41. The process of claim 34, wherein the angle is about 90 degrees.

42. The process of claim 34, wherein the angle is about 180 degrees.

43. A nozzle assembly, comprising:
(a) a substantially longitudinally extending atomizing feed nozzle comprising an atomizing medium conduit and one or more substantially longitudinally extending precursor medium feed conduits; and
(b) a substantially longitudinally extending sheath medium nozzle.

44. The nozzle assembly of claim 43, wherein the nozzle assembly further comprises one or more auxiliary conduits.

45. The nozzle assembly of claim 43, wherein the atomizing feed nozzle comprises one precursor medium feed conduit.

46. The nozzle assembly of claim 43, wherein the nozzle assembly further comprises one or more fuel/oxidant conduits.

47. The nozzle assembly of claim 43, wherein the atomizing medium conduit and the precursor medium feed conduit are substantially coaxial with respect to one another.

48. The nozzle assembly of claim 47, wherein the atomizing medium conduit is located within the precursor medium feed conduit.

49. The nozzle assembly of claim 47, wherein the precursor medium feed conduit is located within the atomizing medium conduit.

50. The nozzle assembly of claim 43, wherein the nozzle assembly comprises a plurality of substantially longitudinally extending sheath medium nozzles arranged in a cylindrical form, each sheath medium nozzle being substantially coaxial with the atomizing feed nozzle.

51. The nozzle assembly of claim 43, further comprising a sheath medium plenum, comprising an inner plenum wall, wherein the sheath medium plenum is in fluid communication with the sheath medium nozzle, and wherein the sheath medium plenum comprises a plenum inlet and a plenum outlet for delivering the sheath medium to the sheath medium nozzle.

52. The nozzle assembly of claim 51, wherein the sheath medium inlet delivers the sheath medium tangentially along the inner plenum wall.

53. The nozzle assembly of claim 43, wherein the nozzle assembly comprises a plurality of substantially longitudinally extending atomizing feed nozzles.

54. The nozzle assembly of claim 43, wherein the nozzle assembly comprises a plurality of substantially longitudinally extending sheath medium nozzles.

55. The nozzle assembly of claim 43, wherein the atomizing medium comprises a gas.

56. The nozzle assembly of claim 55, wherein the gas comprises one or more of air, nitrogen, oxygen, or water vapor.

57. The nozzle assembly of claim 43, wherein the sheath medium comprises a gas.

58. The nozzle assembly of claim 57, wherein the gas comprises one or more of air, nitrogen, oxygen, offgas recycle, or water vapor.

59. The nozzle assembly of claim 58, wherein the sheath medium further comprises atomized water.

60. The nozzle assembly of claim 43, wherein the nozzle assembly is located within a flame spray system.

61. The nozzle assembly of claim 60, wherein the flame spray system is an enclosed flame spray system.

62. A nozzle assembly, comprising:
(a) a substantially longitudinally extending atomizing feed nozzle comprising an atomizing medium conduit and one or more precursor medium feed conduits,
(i) wherein the atomizing medium conduit has a first end for receiving an atomizing medium from an atomizing medium source and a second end through which the atomizing medium exits the atomizing feed nozzle, and
(ii) wherein the precursor medium feed conduit has a first end for receiving a precursor medium from a precursor medium source and a second end through which the precursor medium exits the atomizing feed nozzle; and
(b) at least one substantially longitudinally extending sheath medium nozzle comprising a first end for receiving a sheath medium from a sheath medium source and a second end through which the sheath medium exits the sheath medium nozzle.

63. The nozzle assembly of claim 62, wherein the nozzle assembly further comprises one or more auxiliary conduits.

64. The nozzle assembly of claim 62, wherein the atomizing feed nozzle comprises one precursor medium feed conduit.

65. The nozzle assembly of claim 62, wherein the nozzle assembly further comprises one or more fuel/oxidant conduits.

66. The nozzle assembly of claim 62, wherein the atomizing medium conduit and the precursor medium feed conduit are substantially coaxial with respect to one another.

67. The nozzle assembly of claim 66, wherein the atomizing medium conduit is located within the precursor medium feed conduit.

68. The nozzle assembly of claim 66, wherein the precursor medium feed conduit is located within the atomizing medium conduit.

69. The nozzle assembly of claim 62, wherein the nozzle assembly comprises a plurality of substantially longitudinally extending sheath medium nozzles arranged in a cylindrical form, each sheath medium nozzle being substantially coaxial with the atomizing feed nozzle.

70. The nozzle assembly of claim 62, further comprising a sheath medium plenum, comprising an inner plenum wall, wherein the sheath medium plenum is in fluid communication with the sheath medium nozzle, and wherein the sheath medium plenum comprises a plenum inlet and a plenum outlet for delivering the sheath medium to the sheath medium nozzle.

71. The nozzle assembly of claim 70, wherein the sheath medium inlet delivers the sheath medium tangentially along the inner plenum wall.

72. The nozzle assembly of claim 62, wherein the nozzle assembly comprises a plurality of substantially longitudinally extending atomizing feed nozzles.

73. The nozzle assembly of claim 62, wherein the nozzle assembly comprises a plurality of substantially longitudinally extending sheath medium nozzles.

74. The nozzle assembly of claim 62, wherein the atomizing medium comprises a gas.

75. The nozzle assembly of claim 74, wherein the gas comprises one or more of air, nitrogen, oxygen, or water vapor.

76. The nozzle assembly of claim 62, wherein the sheath medium comprises a gas.

77. The nozzle assembly of claim 76, wherein the gas comprises one or more of air, nitrogen, oxygen, offgas recycle, or water vapor.

78. The nozzle assembly of claim 76, wherein the sheath medium further comprises atomized water.

79. The nozzle assembly of claim 62, wherein the nozzle assembly is located within a flame spray system.

80. The nozzle assembly of claim 79, wherein the flame spray system is an enclosed flame spray system.

81. A nozzle assembly comprising:
(a) a substantially longitudinally extending spray nozzle atomizer; and
(b) a substantially longitudinally extending sheath medium nozzle.

82. The nozzle assembly of claim 81, wherein the spray nozzle atomizer comprises two-fluid nozzle.

83. The nozzle assembly of claim 81, wherein the spray nozzle atomizer comprises three-fluid nozzle.

84. The nozzle assembly of claim 81, wherein the spray nozzle atomizer comprises four-fluid nozzle.

85. The nozzle assembly of claim 81, wherein the spray nozzle atomizer comprises an ultrasonic nozzle.

86. The nozzle assembly of claim 81, wherein the spray nozzle atomizer comprises an air-less nozzle.

87. A method of making product particles, the method comprising:
introducing into a flame reactor heated by at least one flame, a precursor medium comprising a precursor to a component;
forming the product particles, the forming comprising transferring substantially all of the precursor to a component through a gas phase of a flowing stream in the flame reactor and growing the product particles in the flowing stream to a weight average particle size in a range having a lower limit of 1 nanometer and an upper limit of 500 nanometers; and
prior to completion of the growing, quenching the flowing stream in a first quenching step to reduce the temperature of the product particles, the quenching step comprising introducing into the flowing stream a cooling medium that is at a lower temperature than the flowing stream.

88. The method of claim 87, wherein at least a portion of the growing occurs after the first quenching step.

89. The method of claim 87, wherein the growing ceases after the first quenching step.

90. The method of claim 87, wherein the cooling medium comprises a gas.

91. The method of claim 90, wherein the cooling medium comprises a disperse nongaseous material and during the first quenching step, at least a portion of the disperse nongaseous material vaporizes, consuming heat associated with the vaporization.

92. The method of claim 91, wherein the nongaseous disperse material comprises liquid droplets of liquid.

93. The method of claim 92, wherein the liquid is water.

94. The method of claim 87, wherein the method further comprises a second quenching step of the flowing stream to further reduce the temperature of the product particles.

95. The method of claim 94, comprising, after the second quenching step, collecting the product particles, the collecting comprising removing the product particles from the flowing stream.

96. The method of claim 87, wherein the precursor to a component is a first precursor for the product particles, the method further comprising adding a second precursor for the product particles into the flowing stream, with at least a portion of the adding occurring during or after the quenching.

97. A method of making metal-containing product particles, the method comprising: introducing into a flame reactor heated by at least one flame a precursor medium comprising a precursor to a component;
forming the product particles, the forming comprising transferring substantially all of the precursor to a component through a gas phase of a flowing stream in the flame reactor and growing in the flowing stream the product particles comprising a metal phase to a weight average particle size in a range having a lower limit of 1 nanometer and an upper limit of 500 nanometers; and
quenching the flowing stream to reduce the temperature of the product particles, wherein the quenching comprises introducing into the flowing stream a cooling medium that is at a lower temperature than the flowing stream; and
the quenching follows at least a portion of the growing.

98. The method of claim 97, wherein at least a portion of the growing follows the quenching.

99. The method of claim 97, wherein the cooling medium is inert.

100. The method of claim 97, wherein the cooling medium comprises a reactive material.

101. The method of claim 100, wherein the reactive material comprises a precursor including a supplemental component for inclusion in the product particles, and wherein the method further comprises the step of reacting the precursor in the flowing stream to add the supplemental component to the product particles.

102. The method of claim 97, wherein the cooling medium comprises droplets dispersed in a gas.

103. The method of claim 102, wherein the droplets comprise water and during the quenching at least a portion of the water vaporizes to consume heat in the flowing stream.
